(19) United States
(12) Patent Application Publication
(10) Pub. No.: US 2017/0289070 A1
(43) Pub. Date: Oct. 5, 2017

(54) Making a Dialogue Available To an Autonomous Software Agent

(71) Applicant: Microsoft Technology Licensing, LLC, Redmond, WA (US)

(72) Inventors: Graham C. Plumb, London (GB); Lilian Dearith Rincon, San Carlos, CA (US); Farookh P. Mohammed, Woodinville, WA (US)

(73) Assignee: Microsoft Technology Licensing, LLC, Redmond, WA (US)

(21) Appl. No.: 15/419,710

(22) Filed: Jan. 30, 2017

Related U.S. Application Data
(60) Provisional application No. 62/315,481, filed on Mar. 30, 2016.

(51) Int. Cl. H04L 12/58; H04L 29/06; H04M 1/725

(52) U.S. Cl. CPC H04L 51/02; H04L 51/18; H04M 1/72547; H04L 51/16; H04L 63/08

(57) ABSTRACT

A user terminal comprising a processor comprising one or more processing devices configured to run a communication client to establish a communication event with nodes in a communication network; a display on which contact identifiers are displayed, each contact identifier being selectable to initiate a communication event with a node addressed by the contact identifier. A user interface enabling a user to engage in an interaction with the user terminal, including communicating via an established communication events with at least one other node in the communication network associated with a human user, whereby messages in the communication event are available to an autonomous software agent (ASA) to convey an intent conveyed in a dialogue between the user terminal and the human user at the at least one other node, and the processor is configured to receive and present to the user a response to the intent received from the ASA.

### RELATED APPLICATIONS

This application claims priority under 35 U.S.C. 119(e) to U.S. Provisional Patent Application No. 62/315,481, filed Mar. 30, 2016 and titled “Making A Dialogue Available to an Autonomous Software Agent”, the entire disclosure of which is hereby incorporated by reference.

### BACKGROUND

Communication systems allow users to communicate with each other over a communication network by conducting a communication event over the network. The network may be, for example, the Internet or public switched telephone network (PSTN). The communication event may be, for example, a voice or video call or an instant message (TM) chat session. During a call, audio, and/or video signals can be transmitted between nodes of the network, thereby allowing users to transmit and receive audio data (such as speech) and/or video data (such as webcam video) to each other in a communication session over the communication network.

Such communication systems include Voice or Video over Internet protocol (VoIP) systems. To use a VoIP system, a user installs and executes client software on a user device. The client software sets up VoIP connections as well as providing other functions such as registration and user authentication. In addition to voice communication, the client may also set up connections for communication events, for instant messaging (“TM”), screen sharing, or whiteboard sessions.

A communication event may be conducted between a user(s) and an intelligent software agent, sometimes referred to as a “bot”. A software agent is an autonomous computer program that carries out tasks on behalf of users in a relationship of agency. The software agent runs continuously for some or all of the duration of the communication event, awaiting inputs which, when detected, trigger automated tasks to be performed on those inputs by the agent. A software agent may exhibit artificial intelligence (AI), whereby it can simulate certain human intelligence processes, for example to generate human-like responses to inputs from the user, thus facilitating a two-way conversation between the user and the software agent via the network.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The present disclosure relates to a user terminal comprising: a processor, a display, and a user interface. The processor comprises one or more processing devices configured to run a communication client to establish communication event with nodes in a communication network. The communication client causes contact identifiers to be displayed on the display, each contact identifier being selectable to initiate a communication event with a node addressed by the contact identifier. The user interface enables a user to engage in an interaction with the user terminal, the interaction including communicating via an established communication events with at least one other node in the communication network associated with a human user. Messages in the communication event are available to an autonomous software agent (ASA) to convey an intent conveyed in a dialogue between the user terminal and the human user at the at least one other node, and the processor is configured to receive and present to the user a response to the intent received from the ASA. The processor is further configured, on a user sign on with the communication client, to convey an authentication token for access by the ASA

### BRIEF DESCRIPTION OF FIGURES

For a better understanding of the present subject matter and to show how the same may be carried into effect, reference is made by way of example to the following figures, in which:

FIG. 1 shows a schematic block diagram of a communication system according to a first embodiment of the invention;

FIG. 2 shows a schematic block diagram of a user terminal;

FIG. 2a shows a schematic block diagram of a software agent;

FIG. 3 shows a schematic block diagram of a communication system according to a second embodiment of the invention;

FIG. 3a shows a flow chart of a method for autonomously actioning a user intent;

FIG. 3b shows a flow chart of a method by which an autonomous software agent may obtain access to data pertaining to users participating in a communication event;

FIG. 4 shows a flow chart of a second authentication method;

FIG. 4a shows a flow chart of a first authentication method;

FIG. 5 shows a flow chart of a third authentication method;

FIGS. 6 and 7 are flow charts of bot selection;

FIGS. 8A, 8B, 8C, and 8D show an example of an interaction between users and bots;

FIGS. 9, 10, and 11 show an example of a bot provisioning service;

FIGS. 12A, 12B, 12C, 12D, 12E, 12F, 12G, 12H, and 12I illustrate an example of an interaction between users and bots on a user interface.

### DETAILED DESCRIPTION OF EMBODIMENTS

Selecting Bots

In the present disclosure, an autonomous software agent can select from multiple servicing entities a suitable entity for actioning an intent of a user. The intent can be derived from a conversation in which the user is engaged, with the autonomous software agent or another user, at a remote user terminal. Alternatively, the intent can be conveyed in a message directly from the user to the agent, for example in a video or audio call or text message. Where the intent is derived from a conversation, the term ‘listening bot’ is utilised.

The servicing entity selected by the agent can be another autonomous agent, which can be placed in a communication event, such as a chat or call, with the user terminal to enable the user to action the intent.

An intent may be associated with a context defined by context data, which may be made available to the ‘listening bot’ or the selected bot, subject to permissions.

As an example, the ‘listening bot’ can pick out an intent for ‘book a room in Dublin’ or ‘ make a reservation’ from a conversation being held at the user terminal or in a direct chat message. It can optionally obtain context data—e.g. ‘for a work trip’. The user's actual location may be context data in this case—e.g. if the user's present location is Paris, the bot may also pick up that it should provide transport options from Paris to Dublin, as well as reservation options for hotels in Dublin.

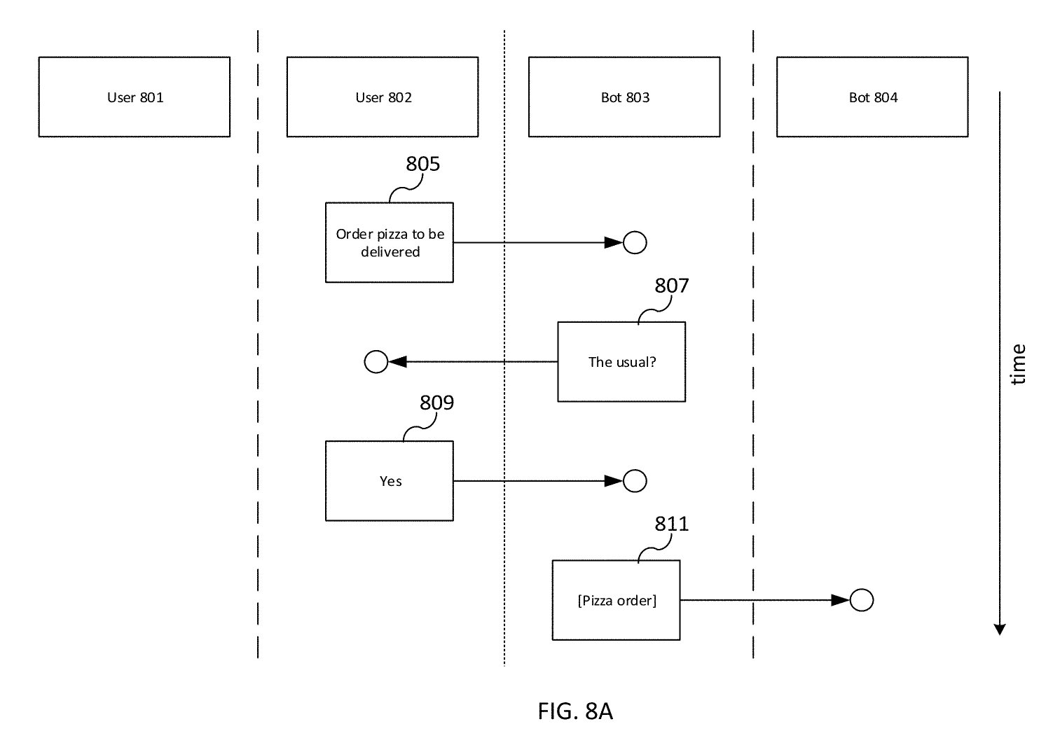

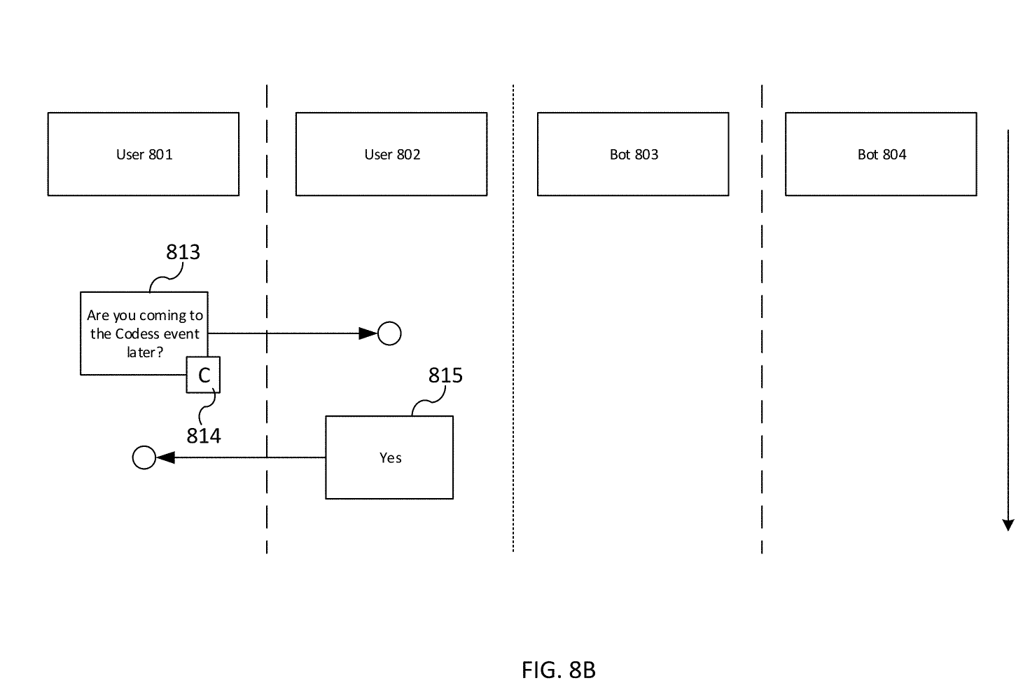

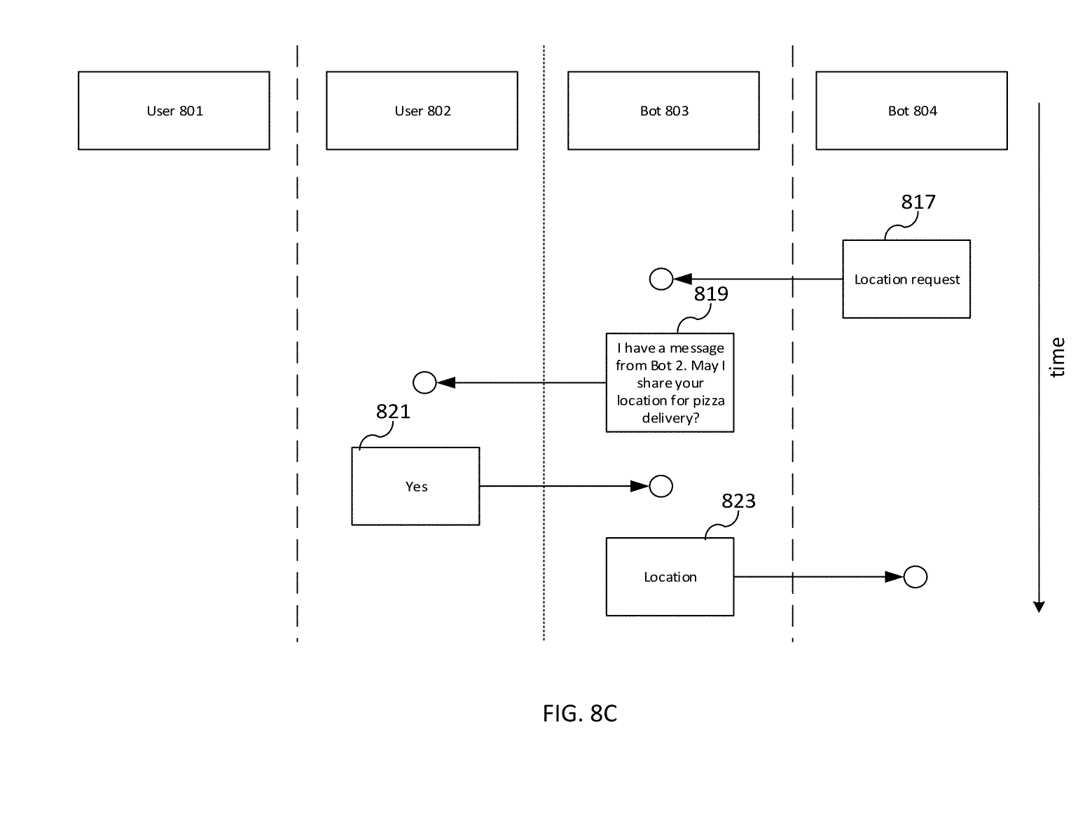

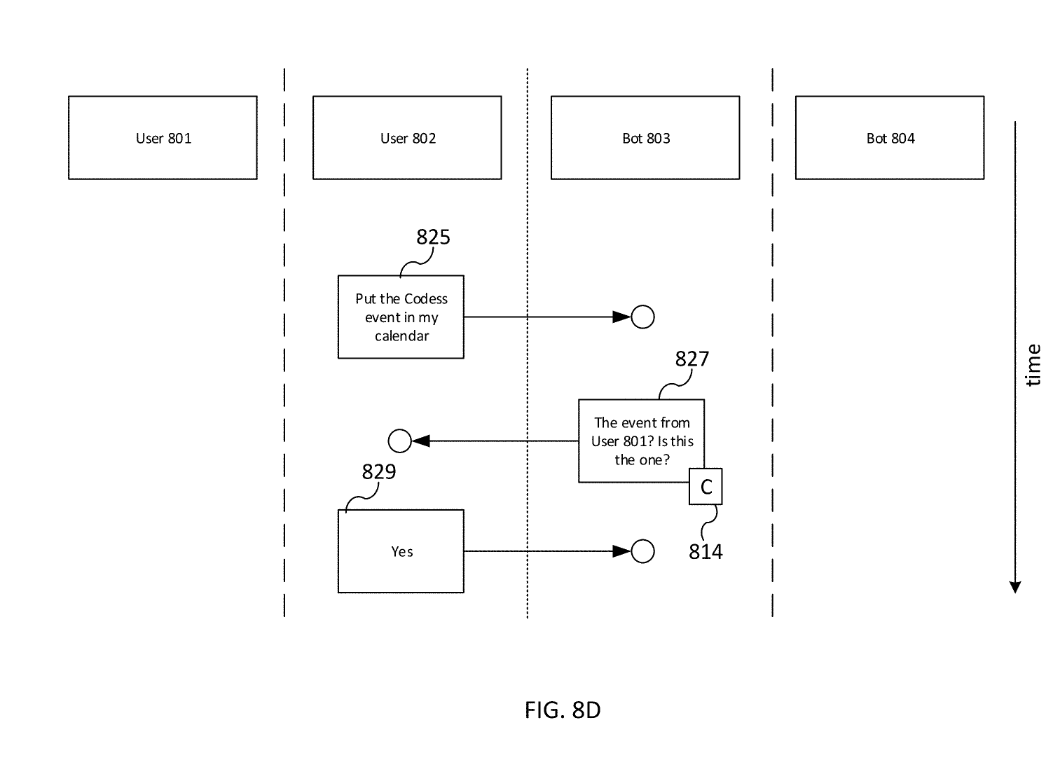

Another example is described later in more detail with reference to FIGS. 8A-8D.

General Communication System

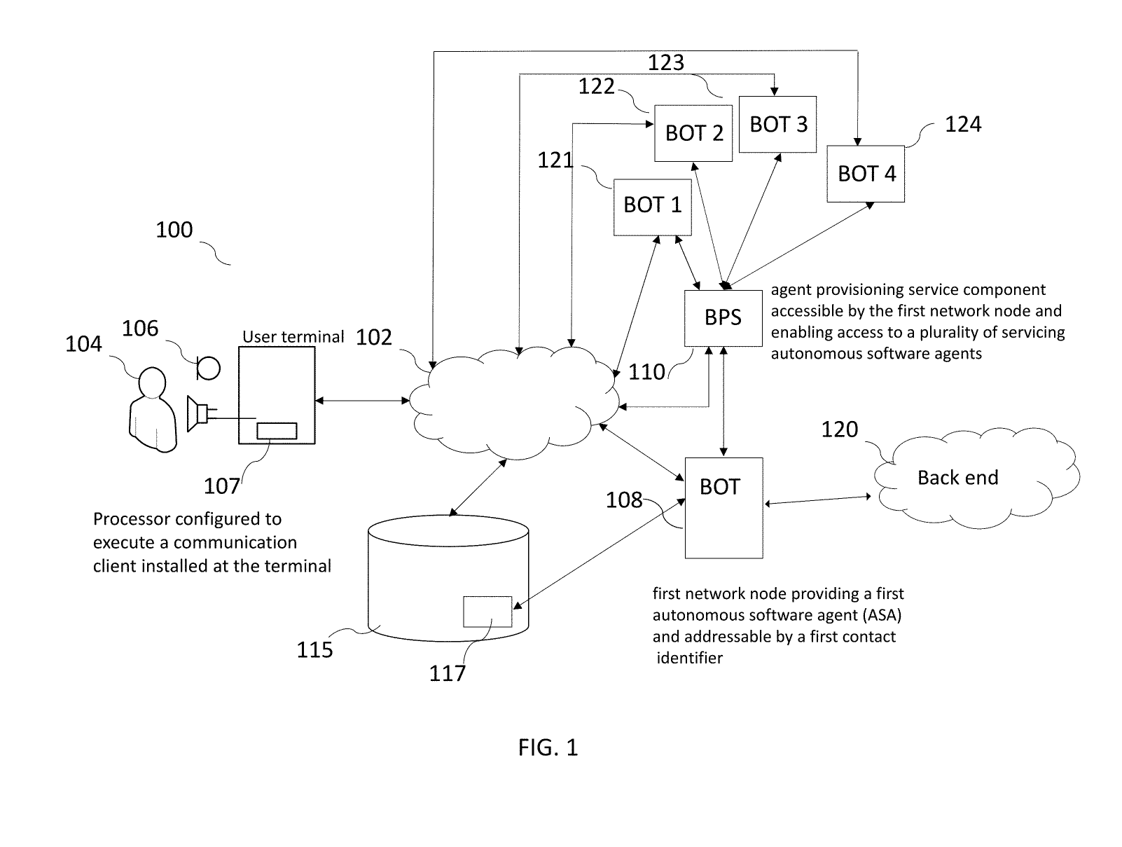

FIG. 1 shows a block diagram of a communication system 100 according to a first embodiment of the present invention. The communication system 100 comprises a communications network 102, to which is connected a first user device 106 and a user account database 115, a bot 108 (remote from the user device 106), a bot back end 120, and a bot provisioning service 110 (agent provisioning service). The network 102 is a packet-based network, such as the Internet.

The user device 106, is available to a first user 104. The user device 106 is shown to be executing a respective version of a communication client 107.

The client 107 is for effecting communication events over a communication service within the communications system via the network, such as audio and/or video calls, and/or other communication event(s) such as a whiteboard, instant messaging, or screen sharing session, between the user 104 and another user (not shown) or between the user 104 and the bot 108.

The communication system 100 may be based on voice or video over internet protocols (VoIP) systems. These systems can be beneficial to the user as they are often of significantly lower cost than conventional fixed line or mobile cellular networks, particularly for long-distance communication. The client software sets up the VoIP connections as well as providing other functions such as registration and user authentication, e.g. based on login credentials such as a username and associated password. To effect a communication event, data is captured from the user at their device. For example, in a call, the data comprises audio data captured via a microphone of the respective device and embodying that user's speech (call audio) transmitted as an audio stream via the network 102, and may additionally comprise video data captured via a camera of the respective device and embodying a moving image of that user (call video) transmitted as a video stream via the network 102. The call audio/video is captured and encoded at the transmitting device before transmission, and decoded at the receiving terminal. The user 104 can thus communicate via the communications network 102 audibly and (for a video call) visually as well as by instant messaging. Alternatively, the call may be established via a cellular or fixed-line (e.g. Public Switched Telephone Network (PSTN)) connection.

Where the remote terminal is a user terminal, the call or chat data is output to a user at the user terminal. Herein a first party terminal is the current user terminal and a third party terminal is a remote user terminal. Where the remote terminal is a bot, the call or chat data is received by the bot and processed to deduce an intent from the conversation being conducted. Context data may also be passed to the bot from the user terminal in some embodiments.

A communication event may be real-time in the sense that there is at most a short delay, for instance about 2 seconds or less, between data (e.g. call audio/video) being captured from one the user at their device and the captured data being received by the bot 108.

Only one user 104 of the communication system 100 is shown in FIG. 1, but as will be readily appreciated there may be many more users of the communication system 100, each of whom operates their own device(s) and client(s) to enable them to communicate with other users via the communication network 102. For example, group communication events, such as group calls (e.g. video conferences), may be conducted between three or more users of the communication system 100.

User Terminal

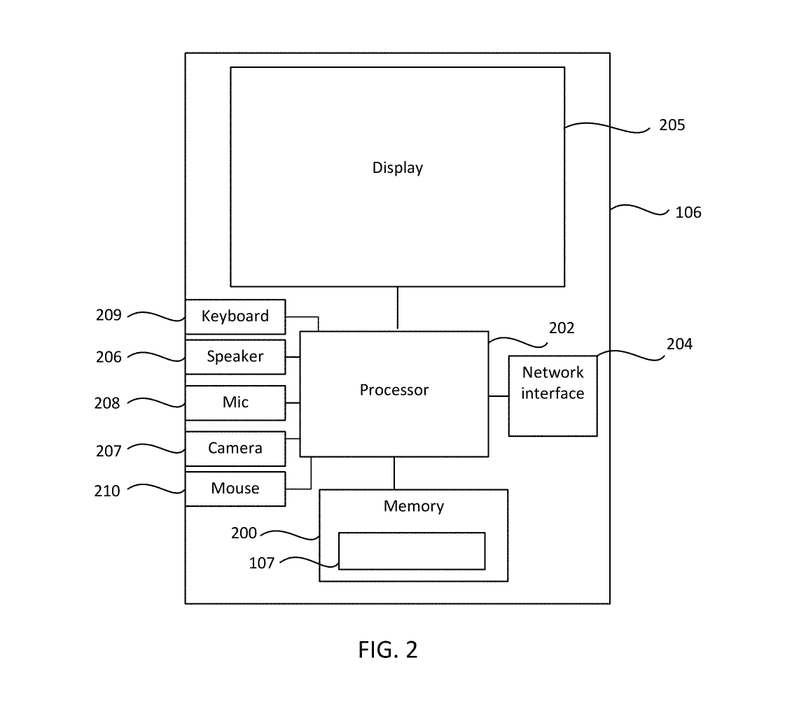

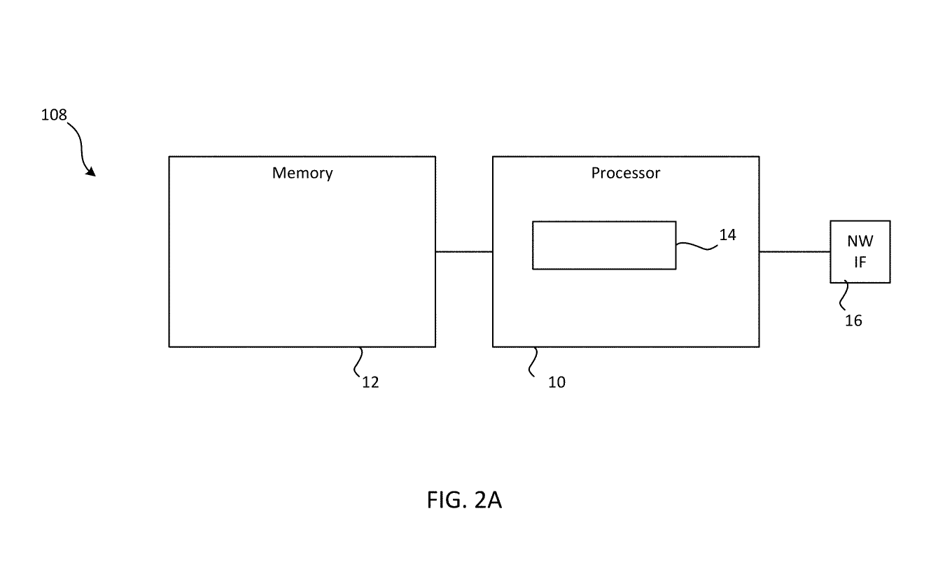

FIG. 2 shows a block diagram of the user terminal 106. The user terminal 106 is a computer device which can take a number of forms e.g. that of a desktop or laptop computer device, mobile phone (e.g. smartphone), tablet computing device, wearable computing device (headset, smartwatch etc.), television (e.g. smart TV) or other wall-mounted device (e.g. a video conferencing device), set-top box, gaming console, etc. The user terminal 106 comprises a processor 202, formed one or more processing units (e.g. Central Processing Units (CPUs), Graphics Processing Units (GPUs), bespoke processing units, etc.) and the following components, which are connected to the processor 202: memory 200, formed on one or more memory units (e.g. Random Access Memory (RAM) units, direct-access memory units, etc.); a network interface(s) 204; at least one input device, e.g. a keyboard 209, mouse 210, camera 207, and microphone(s) 208 as shown; at least one output device, e.g. a loudspeaker (206) and a display(s) 205. The user terminal 106 connects to the network 102 via its network interface 204, so that the processor 202 can transmit and receive data to/from the network 102. The network interface 204 may be a wired interface (e.g. Ethernet, FireWire, Thunderbolt, Universal Serial Bus (USB), etc.) or wireless interface (e.g. Wi-Fi, Bluetooth, Near Field Communication (NFC), etc.). The memory holds the code of the communication client 107 for execution on the processor 202. The client 107 may be e.g. a stand-alone communication client application, plugin to another application such as a Web browser, etc. that is run on the processor in an execution environment provided by the other application. The client 107 has a user interface (UI) for receiving information from and outputting information to the user 104. For example, the client 107 can output decoded IM messages via the display 205. The display 205 may comprise a touchscreen so that it also functions as an input device. For audio/video calls, the client captures call audio/video via the microphone 208 and camera 207 respectively, which it encodes and transmits to one or more other user devices of other user(s) participating in a call. Any of these components may be integrated in the user device 106, or external components connected to the user device 106 via a suitable external interface.

Returning to FIG. 1, the user account database 115 stores, for each user of the communication system 100, associated user account data in association with a unique user identifier of that user. Thus users are uniquely identified within the communication system 100 by their user identifiers, and rendered ‘visible’ to one another within the communication system 100 by the database 115, in the sense that they are made aware of each other's existence by virtue of the information held in the database 115. The database 115 can be implemented in any suitable manner, for example as a distributed system, whereby the data it holds is distributed between multiple data storage locations.

Login Mechanism

The communication system 100 provides a login mechanism, whereby users of the communication system can create or register unique user identifiers for themselves for use within the communication system, such as a username created within the communication system or an existing email address that is registered within the communication system as used as a username once registered. The user also creates an associated password, and the user identifier and password constitute credentials of that user. To gain access to the communication system 100 from a particular device, the user inputs their credentials to the client on that device, which is verified against that user's user account data stored within the user account database 115 of the communication system 100. Users are thus uniquely identified by associated user identifiers within the communication system 100. This is exemplary, and the communication system 100 may provide alternative or additional authentication mechanism, for example based on digital certificates.

At a given time, each username can be associated within the communication system with one or more instances of the client at which the user is logged. Users can have communication client instances running on other devices associated with the same log in/registration details. In the case where the same user, having a particular username, can be simultaneously logged in to multiple instances of the same client application on different devices, a server (or similar device or system) is arranged to map the username (user ID) to all of those multiple instances but also to map a separate sub-identifier (sub-ID) to each particular individual instance. Thus the communication system is capable of distinguishing between the different instances whilst still maintaining a consistent identity for the user within the communication system.

In addition to authentication, the client 107, can provide additional functionality within the communication system, such as presence and contact-management mechanisms. The former allows users to see each other's presence status (e.g. offline or online, and/or more detailed presence information such as busy, available, inactive, etc.). The latter allows users to add each other as contacts within the communication system. A user's contacts are stored within the communication system 100 in association with their user identifier as part of their user account data in the database 115, so that they are accessible to the user from any device at which the user is logged on. To add another user as a contact, the user uses their client 107 to send a contact request to the other user. If the other user accepts the contact request using their own client, the users are added to each other's contacts in the database 115. A contact is displayed on the display of the user terminal with a contact identifier which when accessed causes a communication event to be established with a network node associated with that contact.

All the information relating to presence and contact management mechanism, as well as personalised data for the users accessible by the bot 108 may be stored in a personal data platform 117 comprised in the user account database. In certain embodiments, the information relating to presence and contact management mechanism may alternatively be managed by a separate address book service.

Bot

FIG. 2A shows a block diagram of the bot 108. The bot 108 is implemented on a computer system, which comprises one or more processors 10 (each formed of one or more processing units), memory 12 (formed of one or more memory units, which may be localized or distributed across multiple geographic locations) and a network interface 16 connected to the processor(s) 10. The memory holds code 14 for execution on the processor 10. The code 14 includes the code of the bot functionality. The bot 108 connects to the network 102 via the network interface 16. As will be apparent, the bot 108 may have a more complex hardware architecture than is immediately evident in FIG. 2A. For example, as indicated, the bot 108 may have a distributed architecture, whereby different parts of the code 14 are executed on different ones of a set of interconnected computing devices e.g. of a cloud computing platform.

In accordance with the present invention, the bot 108 may be configured to provide special functionality, as outlined in more detail below.

The bot or primary bot or autonomous software agent (ASA) 108 is implemented on a server comprising a server device or a set of multiple inter-connected server devices which cooperate to provide desired functionality. For example, the bot 108 may be based on a cloud-based computer system, which uses hardware virtualization to provide a flexible, scalable execution environment, to which code modules can be uploaded for execution.

The bot 108 may be an intelligent software agent, the operation of which will be described in due course. The bot 108 is an artificial intelligence software agent configured so that, within the communication system 100, it appears substantially as if it were if another member of the communication system.

The bot 108 may be connected to a back end database 120, which may be a database or a service.

The bot 108 is inherently accessible to the user client 107 as one of the user client's contacts, allowing the user terminal to access the bot 108 directly via a chat service.

Bot Provisioning

The bot is also connected to a bot provisioning service 110. The bot provisioning service 110 may also be connected to the network 102. A first bot, a so called ‘listening bot’ 108 is accessed directly by a user at the user terminal. In some embodiments, the listening bot can select other bots from the bot provisioning service. A selected bot may be connected directly to a user terminal or to the listening bot. The bot provisioning service may take part in establishing such connections.

Once the user terminal 106 is connected to the bot 108, the user 104 can (among other things):

receive or instigate calls from/to, and/or IM sessions with, the bot 108 using their communication client 107, just as they can receive or instigate calls from/to, and/or IM sessions with other users of the communication system 100;

add the bot 108 as one of their contacts within the communication system 100. In this case, the communication system 100 may be configured such that any such request is accepted automatically;

see the bot's presence status. This may for example be “online” all or most of the time, except in exceptional circumstances (such as system failure).

This allows users of the communication system 100 to communicate with the bot 108 by exploiting the existing, underlying architecture of the communication system 100. No or minimal changes to the existing architecture are needed to implement this communication. The bot thus appears in this respect as another user ‘visible’ within the communication system, just as users are ‘visible’ to each other by virtue of the database 115, and presence and contact management mechanisms.

The bot 108 not only appears as another user within the architecture of the communication system 100, it is also programmed to simulate certain human behaviours. In particular, the bot 108 is able to interpret the speech in a user's call audio or in an instant message, and respond to it in an intelligent manner. The bot 108 may formulate its responses as synthetic speech that is transmitted back to the user as call audio and played out to them in audible form by their client 107 just as a real user's call audio would be. The bot 108 may also generate synthetic video, in the form of an “avatar”, which simulates human visual actions to accompany the synthetic speech. The bot 108 may also formulate its responses as text that is transmitted back to the user as an instant message. These are transmitted and displayed as call video or instant messages at the user device 106, in the same way that a real user's video would be.

The bot provisioning service may comprise a database storing the details of the plurality of secondary bots 121, 122, 123, and/or 124. The details stored in the database of the bot provisioning service may include the contact data of each secondary bot, metadata or category information regarding each secondary bot. In certain embodiments, the category information may include the function of the bot and/or the location which the bot is capable of servicing, such as information regarding a bot's function, a bot's location and/or or a bot's privacy statements and availability. The bot provisioning service 110 may also allow users to upload bots that they have created for use within the communication system 100.

In some embodiments the bot provisioning service may be provided by the network node that provides the bot 108 or by another network node in a communication network in which the network nodes are interconnected.

The bot provisioning service 110 may also be connected to a plurality of other bots, secondary bots or servicing autonomous software agents (SASA). Each of these secondary bots is provided at a respective network node. In some embodiments, the secondary bots may be provided at a common network node. Only four additional bots 121, 122, 123, and 124 are depicted in FIG. 1 but as will be readily appreciated there may be many more bots connected to the bot provisioning service 110 of the communication system.

The user account database 115 may also store metadata relating to each bot, the metadata matching each bot to function, location information or logical setup.

By way of example, a bot which has the capability to calculate a transport route in London may be matched to metadata tags such as maps, transport, London, and route calculation.

The primary bot 108 has the capability to retrieve, through the bot provisioning service 110, the contact details of one or more secondary bots 121-124, and communicate those details to the user terminal 106, thus allowing the user terminal 106 to connect to one or more of the plurality of secondary bots 121-124.

In certain embodiments, the first bot may be configured to return contact data of a secondary bot for presentation on the display of the user terminal and, responsive to the user selecting a contact identifier of the contact data the user terminal sets up communication event with SASA addressed by contact data. The contact data may, in some embodiments, be in the form of a swiftcard.

Listening Bot

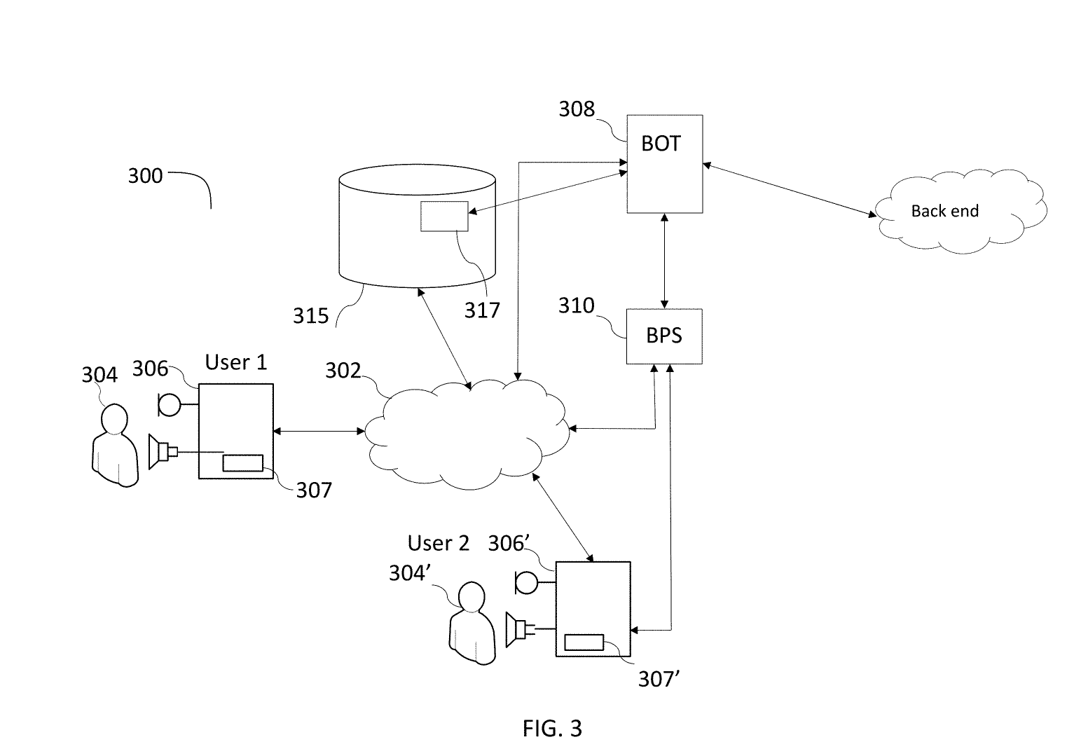

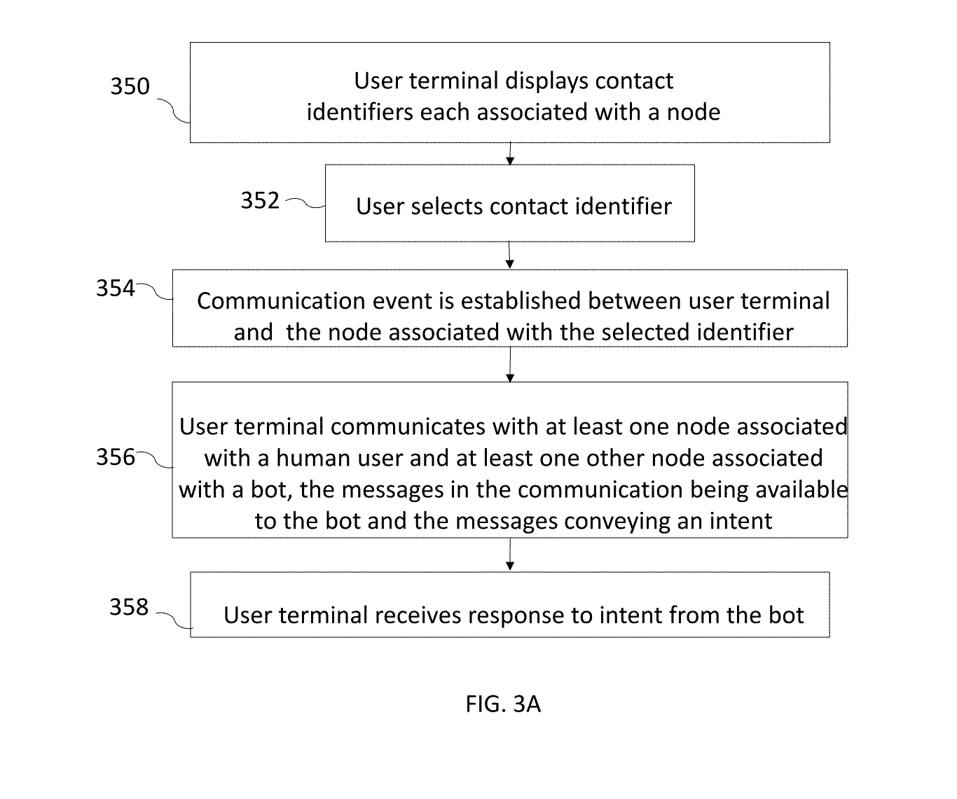

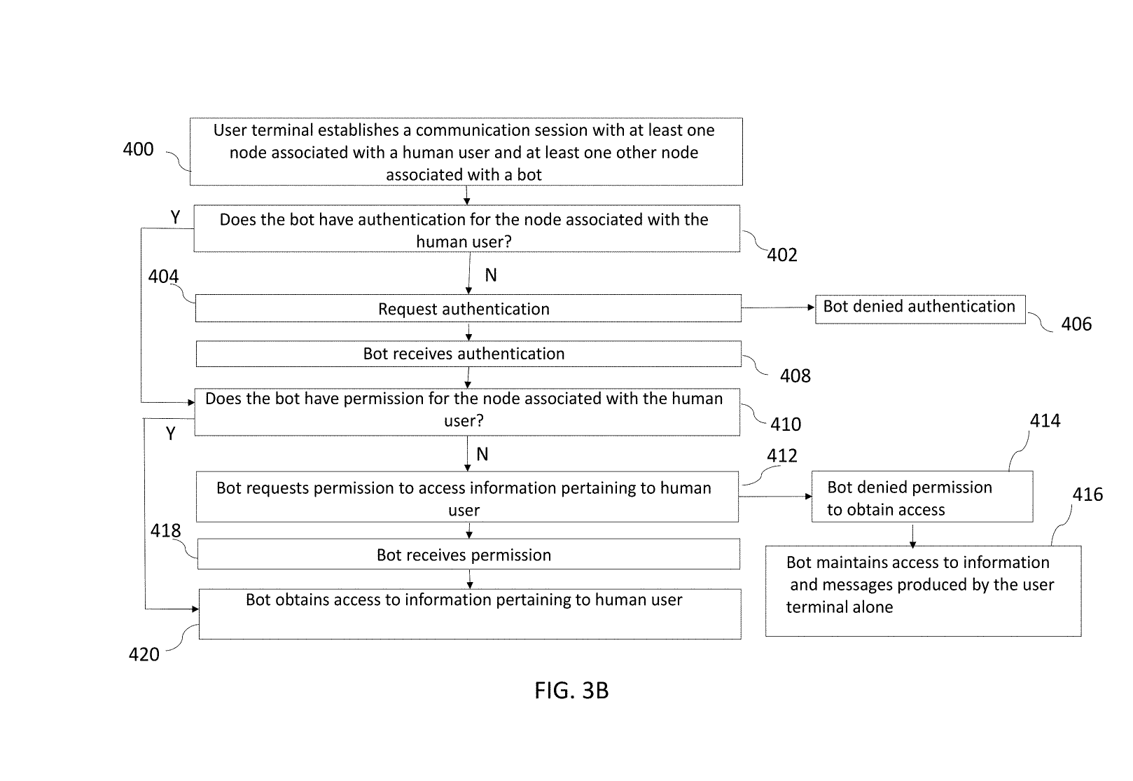

FIG. 3 shows a block diagram of a communication system 300 according to a second embodiment of the present invention. The communication system 300 comprises a communications network 302, to which is connected a first user device 306 and a second user device 306′, a user account database 315, a bot 308 (remote from the user devices 306, 306′), a bot back end 320, and a bot provisioning service 310 (agent provisioning service). The network 302 is a packet-based network, such as the Internet.

The user devices 306, 306′, are available to a first and a second user 304, 304′. The user devices 306, 306′ are shown to be executing a respective version of a communication client 307.

Only two users 304, 304′ of the communication system 300 are shown in FIG. 3, but as will be readily appreciated there may be many more users of the communication system 300, each of whom operates their own device(s) and client(s) to enable them to communicate with other users via the communication network 302. For example, group communication events, such as group calls (e.g. video conferences), may be conducted between three or more users of the communication system 300.

It can be appreciated that the user terminals of FIG. 3 are analogous to the user terminals described with reference to FIG. 2.

It can also be appreciated that the architecture of the communication system 300 of FIG. 3 is analogous to the architecture of the communication system 100 depicted in FIG. 1 and previously described.

The bot provisioning service 310 may enable the bot 308 to access a communication between the first 304 and the second user 304′. In some embodiments the bot 308 may also obtain access to the historic communication between the users.

The bot 308, analogously to the bot 108 described with reference to FIG. 1 can generally directly access a user client.

In embodiments, there are one or two conditions for a bot to have access to a communication event (a session such as an instant message (IM) conversation or VoIP call): authentication and/or permission. Authentication refers to verifying the identity of the bot (to check it is not a malicious party masquerading as a legitimate provider). Permission on the other hand refers to whether a user (or the users) have chosen to allow bot to access their communication event. For a bot 308 to have access to a communication event between several user devices, the bot 308 must meet the authentication condition of at least one of the user devices participating in the communication event.

In embodiments, a user participating in a communication event may be provided with the option to grant the bot with permission to access to the event (for any of one or more of the purposes disclosed herein) by setting a permission setting in a user profile of the user, which may be stored locally on the user's user terminal or more preferably on a server, e.g. in the account database. In alternative or additional embodiments, the user may be provided with the option to grant the bot with the permission to access the communication event by means of a user-actionable prompt output through the UI, e.g. an on-screen prompt such as a pop-up window or text-box, which the bot may provide in order to ask the user for the permission in question. In yet another alternative or additional embodiment, the permission may be implicitly granted when the user invites the bot, as a contact from the user's contact list, to become a participant in the communication session. The authentication then provides confidence that the bot is indeed legitimately the bot the user intends to grant permission.

In a situation where the bot 308 accesses a communication event between two or more users, this connection may typically happen in one of two different ways, as follows.

a) The bot 308 may have automatic access to all the user clients involved in a communication event by virtue of having access to the user client of a single user. In this scenario, the contact between the bot and the users may be direct or via the bot provisioning service, as described with reference to FIG. 1.

b) The bot 308 may need to be authenticated by the other users of the communication event and in turn the other users of the communication event need to be authenticated by the bot 308 in order. In this scenario, at least the initial authentication process is mediated by the bot provisioning service. Once the authentication process has been completed, the contact between the bot and the users may be direct or via the bot provisioning service, as described with reference to FIG. 1.

FIG. 3a shows a flow diagram illustrating a method by which the system illustrated in FIG. 3 may autonomously action a user intent.

Initially, contact identifiers are displayed, in step 350, on a display of a user terminal associated with the user. Each contact identifier may be selectable to initiate a communication event with a node addressed by the contact identifier. By way of example, the contact identifiers may be displayed as a contact list on a user terminal screen.

The user may, in step 352, select a contact identifier. In the context of the previous example this might be implemented, by way of example, by selecting a contact form the contact list.

Upon doing so, a communication event is established, in step 354, between the user terminal and the network node associated with the selected contact identifier. The communication event may, by way of example, be a communication session such as an audio or video call or an IM session.

Once the communication event has been established, the user terminal may communicate, in step 356, with the user human user associated with the network node associated with the selected contact identifier as well as with another node associated with an autonomous software agent or bot 308. The messages in the communication between the two human users may be available to the bot 308. Therefore, an intent conveyed in a dialogue between the two human users may also be available to the bot 308. In the case where the communication event is an IM session, the text of the messages may be made available to the bot.

The bot 308 may then action the intent conveyed by the user terminal. The response to the intent received from the bot may then be received and presented, in step 358, to the user.

In certain embodiments, the communication event from which intent is conveyed to the bot may be a current dialogue in which the user is engaged.

By way of example, the above method may be applied in a situation where user a and user b are exchanging IM messages discussing going for dinner near Dublin on Friday, 24 Jun. 2016. The bot may have access to this message and search for restaurants in Dublin with availability on the selected date and present those results to the users in real time, as the two users are still discussing where to go.

In other embodiments, the communication event from which intent is conveyed may be a historic event.

In certain embodiments, the user terminal of the user may also have the capability to access context data of the user and make this context data available to the bot. Such context data may be, by way of example, credit card details or location data.

In certain embodiments, the bot may first require permission to access the user's context data. For example, the bot may request a permission to access the user's context data. This permission request may be displayed at the user terminal whereby a user can engage with the request. Alternatively, permission may be granted via a setting available at the user end which may grant permission to the bot to access all or certain groups of the user's context data. The setting could be maintained at the user terminal or on a server, e.g. as part of a user profile. In another embodiment, the permission may be granted implicitly by the user having invited the bot, as a contact, to be one of the participants in the conversation.

In certain embodiments, a user may convey an authentication token to the bot upon signing on with the communication client. In other embodiments, the user may receive a request for authentication of the user by the ASA and supply this authentication token in response.

In the situation described above where the bot 308 accesses a communication event between two or more users, access to the users' context data may typically be granted in one of two different ways, as follows.

a) The bot 308 may have automatic permission to access the context data of all the user clients involved in a communication event by virtue of having access to the user client of a single user. In this scenario, the contact between the bot and the users may be direct or via the bot provisioning service, as described with reference to FIG. 1.

b) The bot 308 may need to be granted permission by each of the other users of the communication event individually. In this scenario, at least the initial permission process is mediated by the bot provisioning service. Once the permission granting process has been completed, the bot 308 has access to the context data of all the users involved in the communication event.

FIG. 3b shows a flow diagram illustrating a method by which the autonomous software agent (bot) 308 may obtain access to data pertaining to users participating in a communication event, such as the communication event described with reference to FIG. 3.

First, a communication session is established between at least two user devices, such as user devices 306, 306′ of FIG. 3.

A bot 308 is also a party to the communication event. In some embodiments, the bot 308 may appear as a third contact in the communication event between user devices 306, 306′. As discussed earlier, for the bot 308 to be party to the communication event, the bot 308 must meet the authentication criterion of at least one of the participating user devices. For ease of reference, the user device that has already authenticated the bot will be referred to as user A and the “other” user device will be referred to as user B.

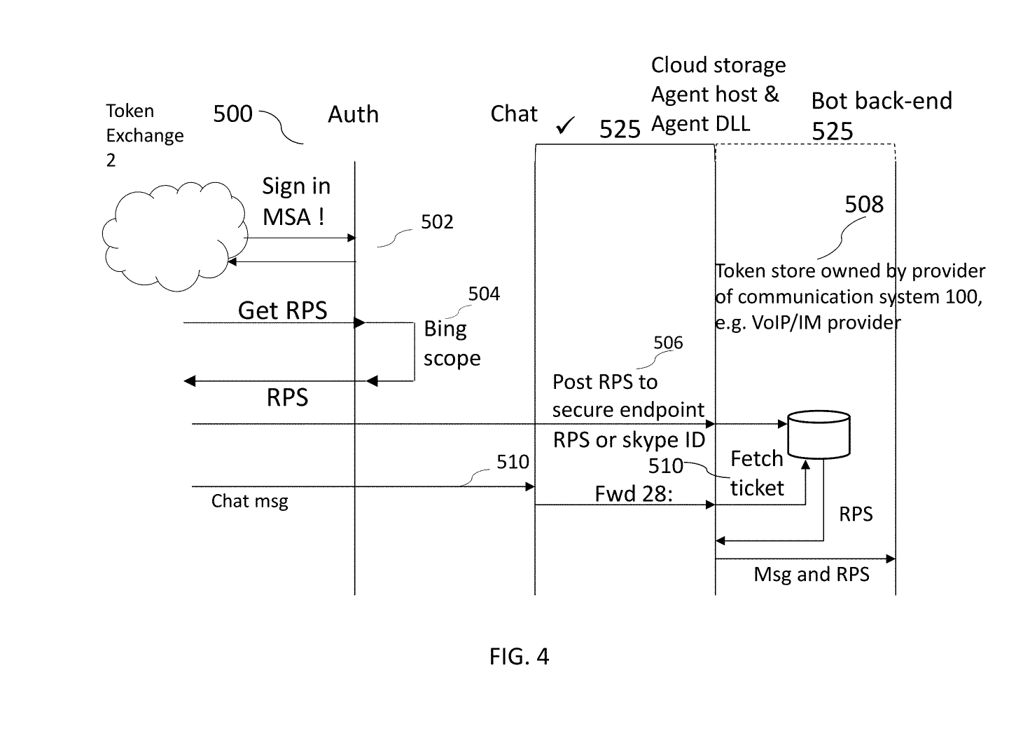

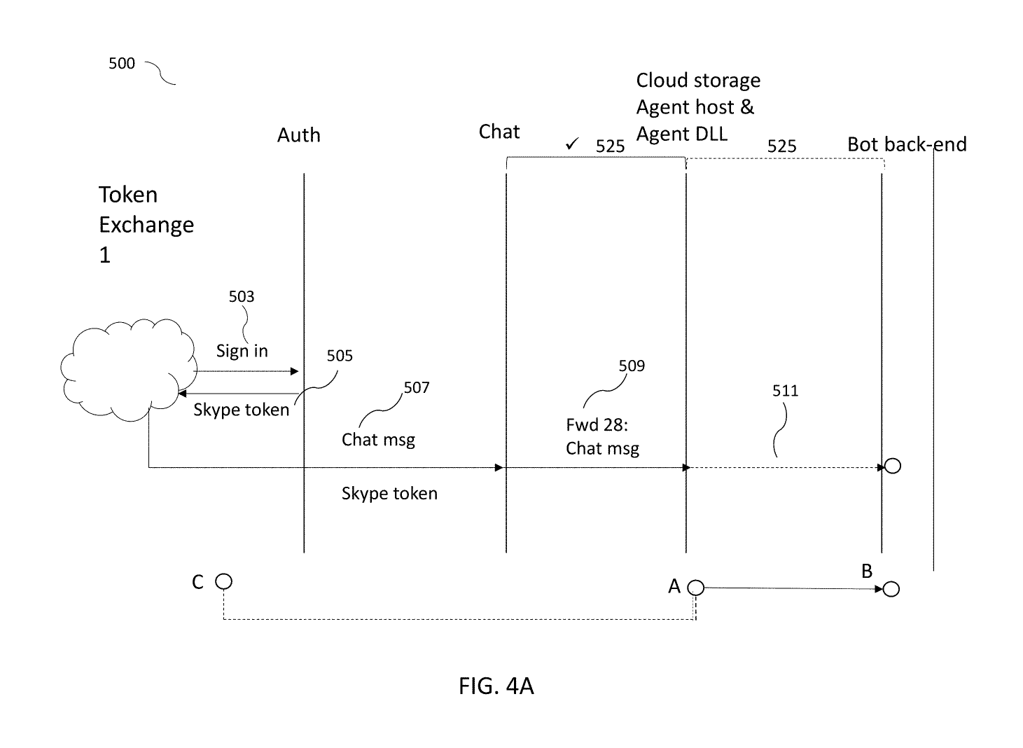

Upon entry of the bot 308 in the communication event, it is first determined, in step 402, whether the bot 308 meets the authentication criteria vis a vis user B. In some embodiments, this may involve the bot 308 checking the backend of bot provisioning service to check whether it already has an authentication token from user B. This may be, by way of example, because the bot 308 was authenticated by user B in a recent communication event or because user B has configured its setting to automatically authenticate bots of the type of bot 308 or because user B has configured its settings to automatically authenticate all bots introduced by user A. The authentication token aspect will be discussed in more detail with reference to FIGS. 4a, 5 and 6.

If it is determined that the bot 308 does not already meet the authentication condition for user B, the bot 308 requests, in step 404, to be authenticated by user B

If the authentication request is denied, in step 406, then the bot 308 may be removed from the communication event.

If the authentication is successful, the bot 308 receives, in step 408, the relevant authentication token for user B.

If it is determined, at step 402, that the bot 308 already has an authentication token for user B, or when the bot 308 receives, in step 408, an authentication token as a result of an authentication request, the bot 308 then determines, in step 410, whether it already meets the permission condition for user B.

If not, the bot 308 requests, in step 412, a permission token from user B.

If the permission request is denied, in step 414, then the bot 308 continues being a party to the communication event, but does not have access to the context data and other information regarding user B. In certain embodiments, the bot 308 may also not be permitted to use the messages emanating from the user B. The bot 308 does however maintain access to the information pertaining to user A and the messages emanating by user A. It is noted that the term messages in this context is not limited to text or IM messages, but may include video or audio messages or parts of speech or image during a call or video call.

Alternatively, once the bot receives permission, in step 418, the bot obtains access to the information pertaining to user B. Thus the bot 308 may continue to be party to the communication event, having access to the messages and information of both users.

Authentication

A first authentication process 500 is shown in FIG. 4a. FIG. 4a shows an authentication flow when sign in to the communication service (e.g. VoIP and/or IM service) is possible.

First, the user signs in to the communication service by entering their authentication details, step 503.

Then the user receives from the communication service an authentication token—such as, by way of example, a Skype sign in, step 505. That is, the authentication token is provided to the client on a user terminal from the Skype backend when a user signs into Skype.

Once the authentication token has been received by the user, the user is able to send a chat message to the agent, step 507. This chat message is sent with the authentication token.

The message and authentication token are then forwarded onto an agent endpoint, step 509. Once this has been completed, the agent is enabled to forward the user's message to the agent back end, step 511. In the present embodiment a Representational State Transfer (REST)-like interface is used to pass tokens into a dynamic link library, but it will be understood that a bot doesn't necessarily have to be coded using windows technologies. A Hypertext Preprocessor (PHP) script, for example, could be used to handle this scenario and implement an agent, in which case the agent endpoint could be embodied in a different way.

In this embodiment, the authentication token can be used in the headers of messages in a communication event such as an IM session between the user terminal and the bot. Note that the authentication tokens can be first or third party tokens—i.e. the current user terminal associated with the bot, or the remote third party with which the first party is engaged in a conversation.

A second, alternative authentication process 500 is depicted in FIG. 4.

FIG. 4 illustrates an authentication technique when token exchange is not handled at the communication service sign in (e.g. where the sign in to the communication service is not possible) and the user signs in using an authentication service such as, by way of example, MSA.

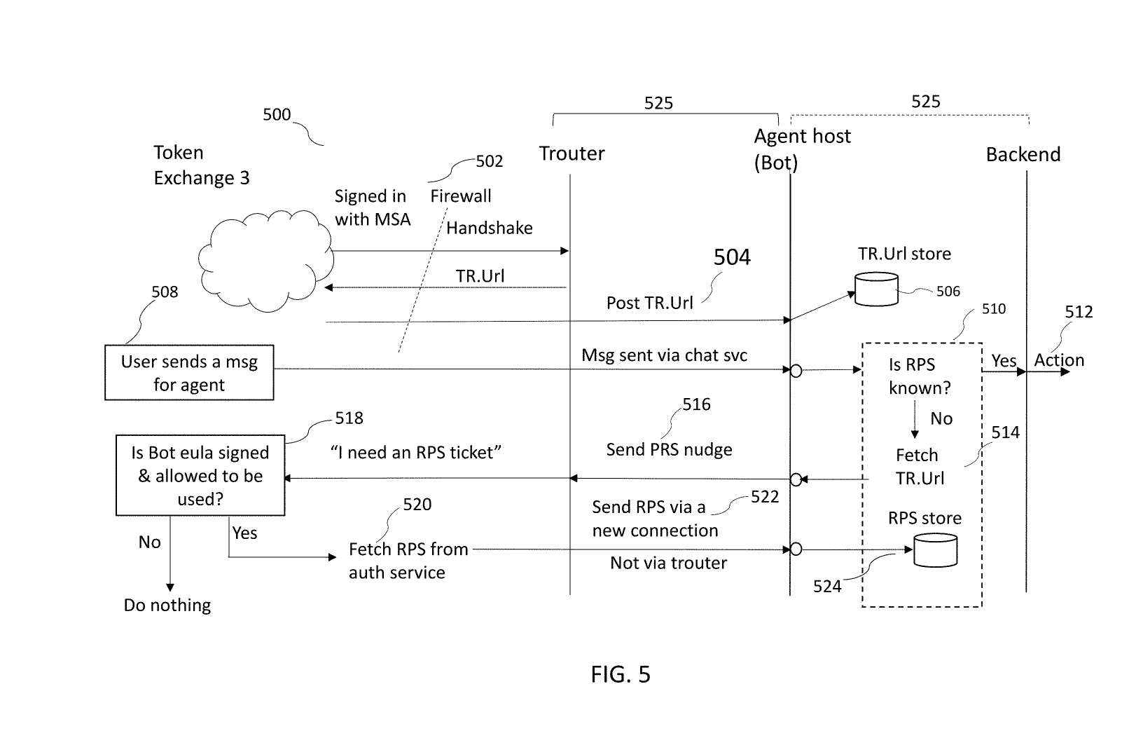

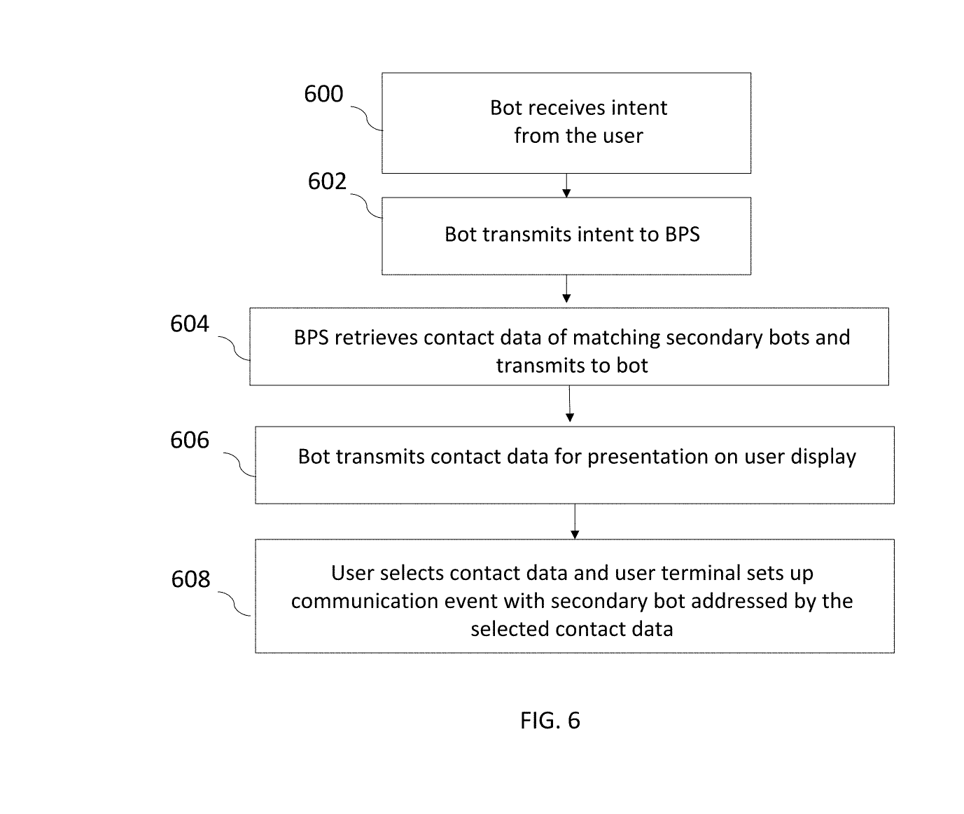

A key issue with the use of bots such as bot 108 and bot 308 described with reference to FIGS. 1 and 3 is security. The systems 100 and 300 of FIGS. 1 and 3 ensure, via the authentication methods described herein with reference to FIGS. 5 and 6 that a bot 108, 308 must first be authenticated by the user before it acquires access to the user's data and personal information as well as to the back end services 120, 320.

The backend service (or collection of services) require user authentication and authorization prior to access for both first and third parties.

According to this authentication process 500, the user first signs in with the communication system 100, 300, in step 502, using a mail submission agent (MSA).

Upon signing in with the communication system, step 502, the user also requests and receives, in step 504, an authentication token suitable for agent back end authentication. This authentication token can be used to allow back end access to a bot 108, 308 or agent. This token may, by way of example, be an RPS authentication token.

The authentication token is then transmitted, in step 506, from the user to a secure end point accessible by the agent or bot. The authentication token is then stored, in step 508, at the personal data platform 117, 317 of FIGS. 1 and 3 which holds all personal data, and is accessible by the bot 108, 308.

These steps may be performed automatically upon a user authenticating, or signing in with a communication system 100, 300, thus automatically authenticating the agent or bot to access.

After the above-described procedure has been completed, when the user transmits a message to the agent in step 510, the agent or bot simply retrieves the user's authentication token from the personal data platform where it is already stored. The agent or bot is thus instantly authenticated and allowed access to the back end, and the user's message and authentication token may be forwarded to the agent backend. A sign in flow could be modified to include retrieving additional tokens or scopes.

A third authentication method is described with reference to FIG. 5 which is an alternative to authentication method of FIG. 4.

FIG. 5 shows token exchange when sign in to the communication service (e.g. the VoIP and/or IM service) is not possible and the user signs in via a proxy, referred to herein as Trouter or Transmission Control Protocol/Internet Protocol (TCP/IP) Router. The name Trouter is used herein to denote a proxy that clients connect to on start-up. Once connected, Trouter maintains this socket to allow the communication service's backend to selectively push or receive signals to/from that client, effectively tunnelling through any firewalls or routers that a given client may be using. It can be used to notify a running communication client instance that there is an incoming call, but it can also function as a general purpose communications channel.

According to the authentication method described below, a bot 108, 308 or agent does not acquire authentication immediately upon the user's login, but only if the user “summons” the bot 108, 308 or agent.

The user first signs in, in step 502, with the communication system 100, 300 using a mail submission agent (MSA) via the Trouter proxy through any firewalls or routers the client may be using. The Trouter proxy then responds by transmitting to the user a Trouter Uniform Resource Locator (URL).

The user then transmits, in step 504, the Trouter URL to the agent or bot. The agent or bot stores, in step 506, the user's Trouter URL at the personal data platform 117, 317 of FIGS. 1 and 3 which may further comprise a Trouter URL store, and is accessible by the bot 108, 308.

The above-described sequence of events takes place immediately upon a user's signing in with the communication network. After this sequence of events has been completed, when the user wishes to communicate with the agent or bot, the following sequence takes place.

The user transmits, in step 508, a message directed to the agent.

This message may be forwarded via instant messaging service (SVC) to the agent or bot. Once the message is received at the agent or bot, it is examined, in step 510, whether the agent already has an authentication token for the user. This may be the case if, for example, the user has already used the agent or bot earlier in the communication session.

If the agent already has an authentication token for the user, then the agent or bot may connect to the back end without any further authentication steps, in step 512. The user's message is forwarded to the backend, and the user request is actioned accordingly.

If the agent does not already have the user's authentication token, then the agent retrieves, in step 514, the Trouter URL associated with the user that has been stored at an agent database comprised in the personal data platform 117, 317.

Once the user's Trouter URL has been retrieved from the agent database, the agent transmits, in step 516, an authentication token request to the user. The authentication token request informs the user end that an authentication token must be transmitted to the agent.

It is then examined, at the user end, in step 518, this is a check to determine whether the agent is actually allowed to possess ticketing information.

The purpose of this is two-fold.

First, it provides an (optional) opportunity for the communication client to present a consent dialog to the user on his display (“WidgetBot is requesting to perform an operation on your behalf, allow? Y/N”). No consent=no ticket=no backend access. The second is a security measure to guard against malicious agents. In order to be addressable inside the communication service, a bot is provisioned in a portal. At this point, a bot's capabilities are registered (which will include whether they are allowed 1st or 3rd party MSA authentication tokens). Armed with this information, a client can determine if a given agent should even be making this kind of request and whether to expose sensitive ticketing data to it or not.

If the agent 108, 308 is not already authenticated with the user, then nothing happens.

If the agent is already authenticated with the user, then the user retrieves its authentication token from its authentication service and transmits its authentication token to the agent. Trouter is one mechanism by which an agent could request the ticket from a communication client at run-time. However, it does not have to go via the Trouter proxy. The resulting ticket response could go through Trouter, or chat service or any intermediary service that then forward the appropriate data to the agent, step 522.

The agent then stores the user's authentication token in an agent database that comprises an authentication token store, step 524.

The agent then acquires authentication and the user's message can then be transmitted to the agent back end and be actioned.

If secondary bots 121-124 require access to the back end, as was described with reference to FIG. 1, then it is the first bot which manages the authentication of these secondary bots 121-124 using an authentication method analogous to the method described above.

The agent first accesses the personal data platform 117, 317, to examine whether the secondary bot 121-124 already has an authentication token, associated with the specific user. If the secondary bot 121-124 does not already have an authentication token associated with the user, the bot 108, 308, retrieves the Trouter URL associated with the user that has been stored at the agent database comprised in the personal data platform 117, 317.

Once the user's Trouter URL has been retrieved from the agent database, the agent transmits an authentication token request to the user, requesting an authentication token for the additional bot 121-124. The authentication token request informs the user end that an authentication token for the secondary bot 121-124 must be transmitted to the agent or bot 108, 308.

The user retrieves the authentication token for the secondary bot 121-124 from its authentication service and transmits the authentication token to the agent 108, 308. Trouter is one mechanism by which an agent could request the ticket from a communication client at run-time. However, it does not have to go via the Trouter proxy. The resulting ticket response could go through Trouter, or CHAT service or any intermediary service that then forward the appropriate data to the agent. The agent 108 then stores the user's authentication token associated with the secondary bot 121-124 in the agent database agent database comprised in the personal data platform 117, 317.

The secondary bot 121-124 then acquires access authentication for the back end.

Selecting Bots

Turning back to the system of FIG. 1, below is described a method with which the primary bot 108 may enable other, secondary bots 121-124 to establish a connection with the user 104. The different bots 108, 121-124, may be distinct from one another in that they are provided by different parties (e.g. different companies). And/or they may be distinct from one another in that they appear as different contacts in the user's contact list, and/or as different participants in a given communication event (given session, e.g. given IM chat conversation or VoIP call). And/or the different bots may be distinct from one another in that they require separate permission and/or separate authentication to be involved in a given communication event (a given session such as a given IM chat conversation or VoIP call) e.g. to be a participant or to listen in on it, and/or to share context data (see later).

Initially the bot receives, in step 600, an intent from the user 104. As mentioned, the intent could be conveyed directly to the bot in a chat message, or derived from a conversation with a third party.

Subsequently the bot transmits, in step 602, the received intent to the bot provisioning service 110.

The bot provisioning service 110 is configured to match the received intent to a category. The bot provisioning service 110 queries the account database 115 in order to establish whether any of the secondary bots 121-124 match the intent content. If the query establishes that one or more secondary bots match the intent, the bot provisioning service 110 retrieves the contact data of the matching secondary bots and forwards them to the bot 108 in step 604.

Once the relevant contact data has been received by the bot 108, it is transmitted, in step 606, to the user terminal 106 for presentation on the user display.

By way of example, if the content of the intent relates to booking a hotel, the bot provisioning service may retrieve bots associated with booking services or bots associated with a specific hotel. The bot 108 may then forward the contact data of these matching bots, such as by means of a swiftcard.

In some embodiments, the bot 108 may further be configured to extract context data from the user terminal and supply the context data to the selected bot to implement the action. In the context of the hotel booking example this may involve, once the user has selected the bot of preference, retrieving the user's credit card details in order for the booking by the secondary bot to take place without the need for the user to enter any additional information.

In some embodiments, the bot 108 may further be configured to obtain information from the secondary bot and provide said information to the user terminal. In the context of the hotel booking example this may involve, obtaining price quotes from the selected bots and presenting the quotes directly to the user.

In some embodiments, the bot provisioning service may be located at the first network node. Alternatively, the bot provisioning service may be located at another network node. In certain embodiments, the bot may be configured to send an intent to the bot provisioning service.

In some embodiments, the bot 108 may be configured to capture the intent conveyed by a conversation in which the user is a participant.

In certain embodiments, the bot 108 may be authorized to conduct the selection of the secondary bot without user input.

In certain embodiments, to implement an action corresponding to the intent conveyed, the first network node accesses the bot provisioning service which enables access to a plurality of servicing autonomous software agents, each capable of implementing an action, and the first network node responds to the received intent by selecting one of the servicing autonomous agents to implement an action corresponding to the intent. In certain embodiments the action may be implemented by transmitting a message to the user terminal in a communication event established between the user terminal and the first network node by the communication client based on selection of the contact identifier.

Context Data Supplied to a Servicing Entity

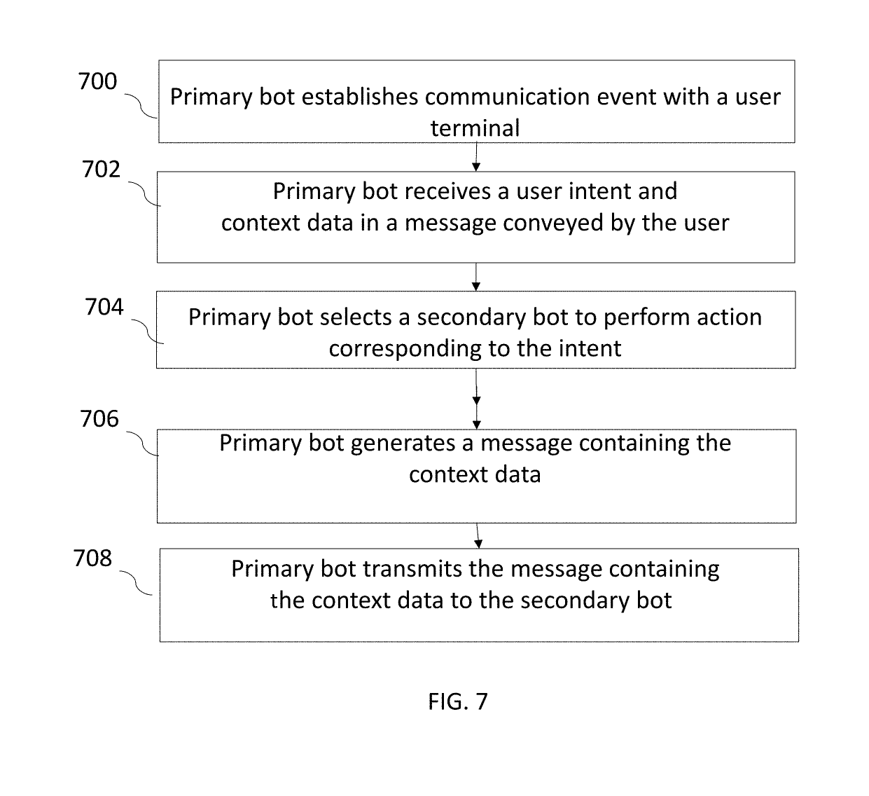

Turning to FIG. 7, the method by which the primary bot may receive and supply the aforementioned intent and context data will be described in more detail.

A communication event is initially established by a user terminal 106, 306 over the communications network 100, 300, step 700. The communication event may, by way of example, be a communication session such as an IM conversation of a video or audio call between the user terminal and the secondary bot. The communication event may be a group communication event in which another user terminal is connected. By way of example, the communication event may be a chat between three human users.

The primary bot then receives, in step 702, in a message conveyed in the communication event, a user intent and user context data. The primary bot may be an AI software agent. In certain embodiments, the intent is derived by the bot from an exchange of messages in a group communication event between the user terminals. By way of example, the bot may use language recognition techniques, such as natural language processing, to process the messages or audio of the dialogue between the parties of the communication event and derive the intent. Similar techniques may also be used to derive context data. In the case of context data, this might also be harvested from a user's profile information such as gender and status (e.g. connected, busy, offline, etc.). It should be noted that the primary bot may not necessarily be a participant in the communication event as such—by way of example the primary bot may have access to the real time data or transcripts of a communication event or session that is established between two users.

The primary bot then selects, in step 704, a secondary bot 121-124 to perform an action corresponding to the intent. The secondary bot may be provided at a separate network node or at a common network node. In certain embodiments, the secondary bot, or other servicing entity, is selected based on matching a category of intent obtained from the user intent to a category of servicing entity.

The bot 108, 308 then generates, in step 706, a message containing the context data provided by the user terminal 106, 306.

Subsequently, the primary bot transmits, in step 708, the message containing the context data to the secondary bot 121-124.

In certain embodiments, the secondary bot may be an autonomous software agent selected by the computer program product to deliver the action autonomously to the user terminal via a separate communication event. The secondary bot may in certain cases be replaced by another servicing entity such as a website.

In certain embodiments, a communication event may be established with the servicing entity at the node, and the message containing the context data may be transmitted within the communication event. In certain embodiments, establishing a communication event with the servicing entity may involve receiving and responding to a request received from the user terminal.

In certain embodiments, the permissions associated with the user of the user terminal and the secondary bot may be determined.

In certain embodiments, users obtain permission to transmit context data by accessing the personal data platform 117, 317 of FIGS. 1 and 3 which holds the permissions for users.

In certain embodiments, the secondary bot 121-124 may deliver the action to the user terminal by establishing a separate communication event between the secondary bot 121-124 and the user terminal 106, 306.

In certain embodiments, the primary bot 108, 308 may autonomously connect with the secondary bot and transmit the message containing the context data to the secondary bot.

In certain embodiments, upon establishing a communication event between the user terminal and the secondary bot, the user terminal may also receive a request for permission for the servicing entity to receive context data from the user.

It should be noted that different permissions may be associated with different types of context data and personal information, and different permissions may apply to different secondary bots and different users.

To illustrate what is meant by different permissions may apply to different types of context data, an example would be that a user may give permission to the bot or secondary bot to have access to his location information but may not to his credit card information. In a different example where different permissions apply to different bots, the primary bot may have access to bot location and credit card information, whereas the secondary bot may only have access to location information.

To illustrate the different permissions for different users' concepts, an example would be a conversation between users A and B in which the two users discuss booking a hotel and the primary bots actions the intent by booking the hotel using user A's credit card details and returns a booking confirmation to the conversation between the two users, the booking confirmation containing the details of the credit card that was used. It may be the case that user A is reluctant to share the credit card details with user B. In this case, the credit card details will be redacted from the image the booking confirmation shown in the conversation.

In certain embodiments, the bot may determine that additional information is required to deliver the action of step 704. In this case, the bot may transmit a request to be surfaced at the user terminal to request the additional information.

In certain embodiments, when selecting a bot or other servicing entity for a specific intent, they primary bot may do this using the user's current context, such as the user's current location, the user's past history, and the user's preferences. By way of example, when the intent is to order a taxi and the user's location is San Francisco (SF), the bot may take this location into account and e.g. consider that Uber is the common service for reserving a taxi in SF, that the user's past history indicates that the user has reserved a taxi using Uber before and also take into account the user's preferences, e.g. the user may already have the Uber app installed or may have indicated that he prefers using Uber.

When selecting a bot, the primary bot may pass the current context to the secondary bot so the user is not required to communicate it again. E.g. if the user has indicated to the primary bot “I need a taxi to pier 39”, the bot already knows this and it does not need to request information from the user regarding this matter again.

In certain embodiments, after the user completes a transaction with the secondary bot, information about the transaction may be passed back to the primary bot for future reference and for affecting the user preferences.

FIGS. 8A-8D illustrate an example of an interaction between users (i.e. humans) and bots which might take place e.g. over the course of a day. In this regard, FIGS. 8A-8D illustrate successive instances of message exchange (i.e. FIG. 8B takes place after FIG. 8A, FIG. 8C after 8B, and FIG. 8D after 8C). In FIGS. 8A-8D, User 802 has a personal assistant Bot 803. A further user, User 801 is shown who may or may not have a personal assistant bot of his own. A further bot, Bot 804 is also shown.

In the example interaction shown in FIG. 8A, User 802 wishes to order pizza. To accomplish this, User 802 sends a message 805 to Bot 803 telling the bot to order pizza. Bot 803 can then request further details if required (such as what type of pizza, and where from). Bot 803 has access to historical data about User 802 which allows the bot to send message 807 asking if User 802 wants “the usual” (i.e. a specific pizza order the user has ordered at least once before). User 802 confirms with message 809. At this point, Bot 803 has been tasked with a pizza order and can contact another bot (Bot 804) as appropriate. For example, FIG. 8A relates to a pizza order, so Bot 804 will be a pizza-related bot (e.g. a business-specific bot associated with the particular pizza shop to which the order is being sent, or a goods/services-specific bot such as a food ordering bot). In FIG. 8A, the pizza order 811 is sent to Bot 804 and thus the order is placed.

Later, User 802 receives a message 813 from User 801, as shown in FIG. 8B. This message might have some context data 814 as shown in FIG. 8B where the message 813 be an invitation to an event and the context data 814 relates to the event (e.g. title, time, place, etc.). Although not shown in FIG. 8B, it is appreciated that Bot 803 can “listen in” to this message as received by User 802 and therefore be aware of the context data (e.g. store it locally for use as described later). Bot 803 may save the context data as particularly relevant if the user responds in the affirmative as shown by message 815 in FIG. 8B.

In FIG. 8C, the pizza ordered in FIG. 8A is now ready to be delivered but the pizza shop does not have the current location of User 802. In this case, Bot 804 communicates with Bot 803 by sending a location request 817 to Bot 803. Bot 803 may then inform User 802 by sending a message 819 to the user indicating that the pizza bot, Bot 804 wants his location. User 802 then confirms with message 821 that Bot 803 has permission to share his location, and thus Bot 803 can send the location in message 823 to Bot 804. The pizza delivery can then be completed as the pizza shop (via its bot) now has the location of User 802.

Later, as shown in FIG. 8D, User 802 wishes to add User 801's event to his calendar. To do this, User 802 simply sends message 825 to Bot 803 instructing it to add the event to his calendar. Bot 803 can recognise the event which the user is referencing due to “listening in” on previous conversations (i.e. the conversation shown in FIG. 8B) and storing relevant data, e.g. temporarily caching context data 814. In the example of FIG. 8D, Bot 803 has recognised the event by name (“Codess”) and retrieved the context data 814 from memory. Bot 803 can thus check with User 802, using message 827, that it has the correct event before adding it to the calendar. Once the user confirms with message 829, the event is added to the calendar. The context data in this example includes information relating to the date/time of the event but it is appreciated that the context data might include any relevant context data (e.g. event location). If the required context data for a particular action is missing (e.g. if the user asked the bot to add the event to his calendar but the context data did not include date/time) then the bot can send additional messages (not shown in FIG. 8D) in order to request this data from the user.

In the context of the embodiments in which no communication event is established between the user terminal 106 and the secondary bot 121-124, a permission request may be sent to the user terminal 106 for the user 104 to grant permission for the secondary bot to receive context data.

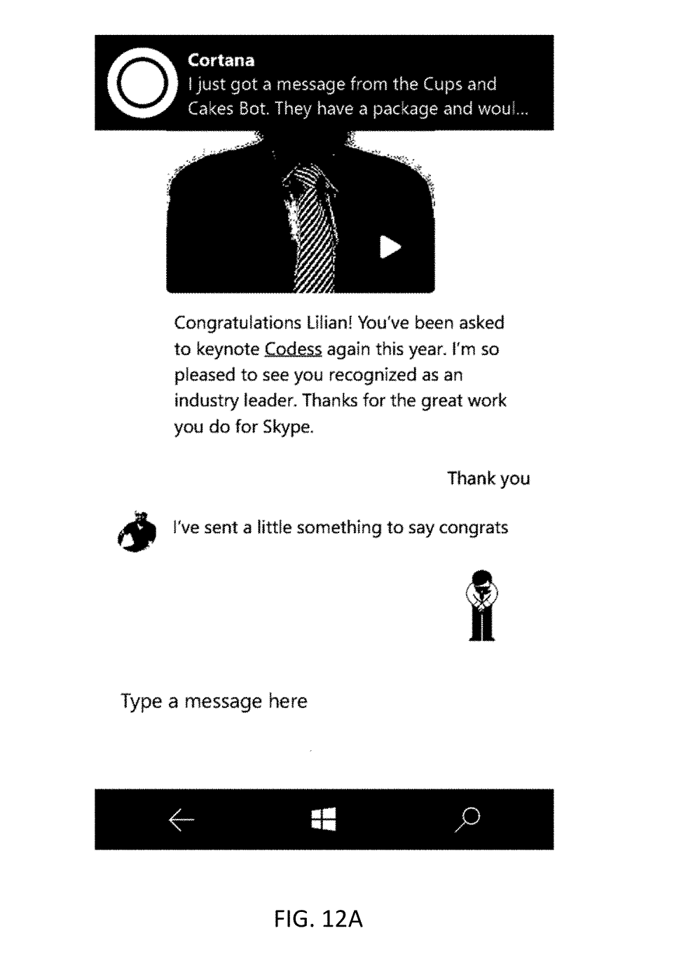

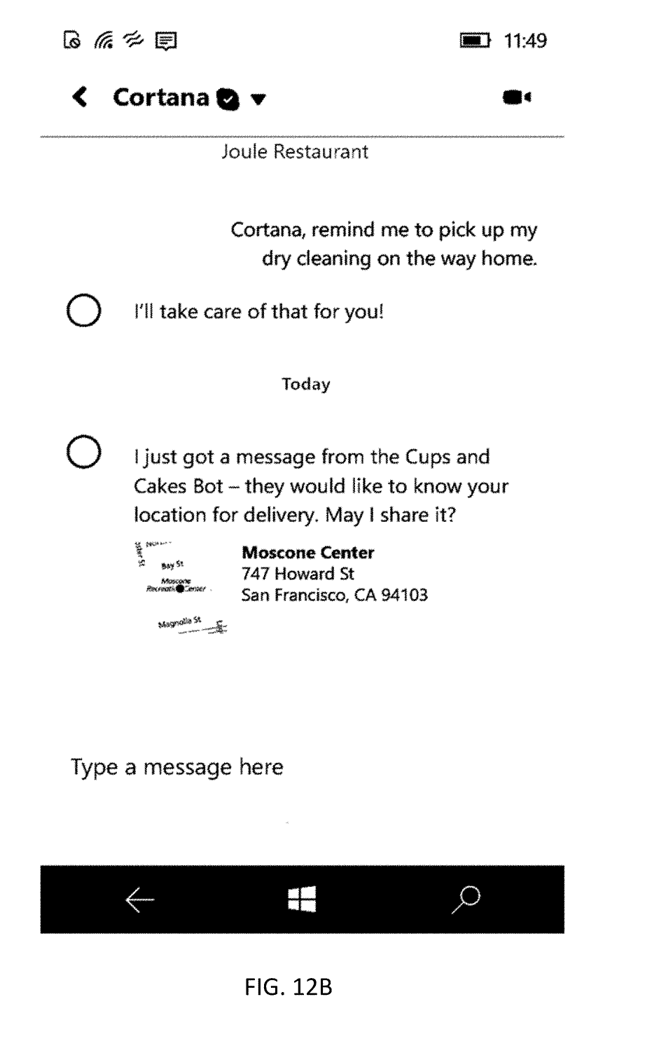

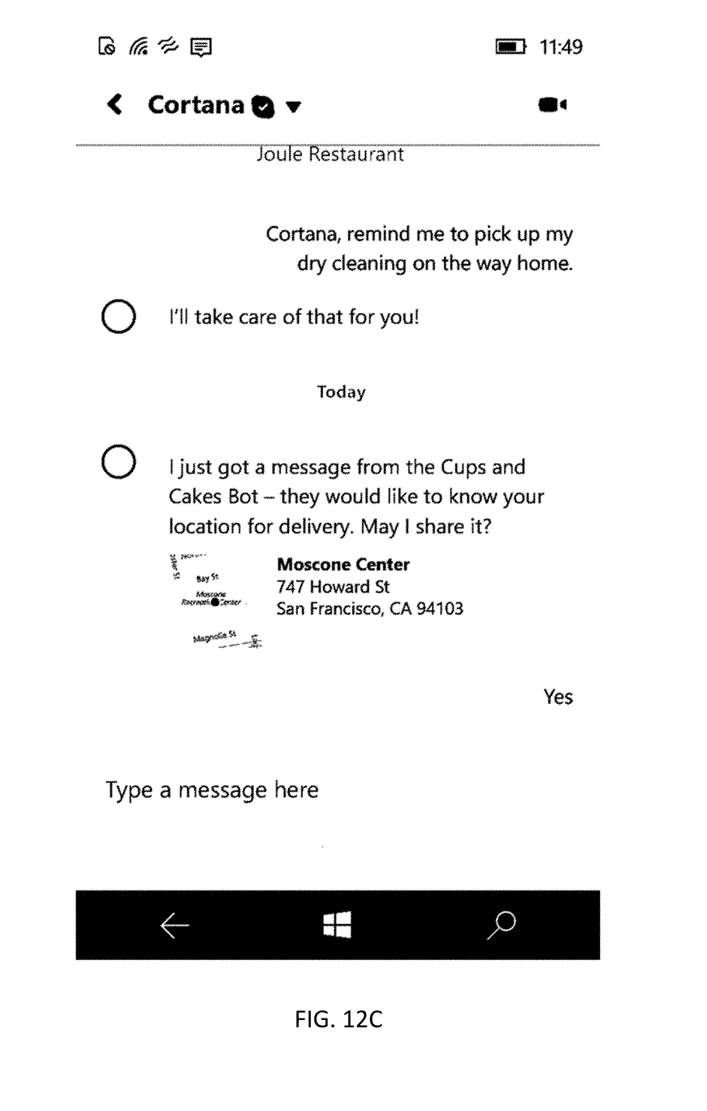

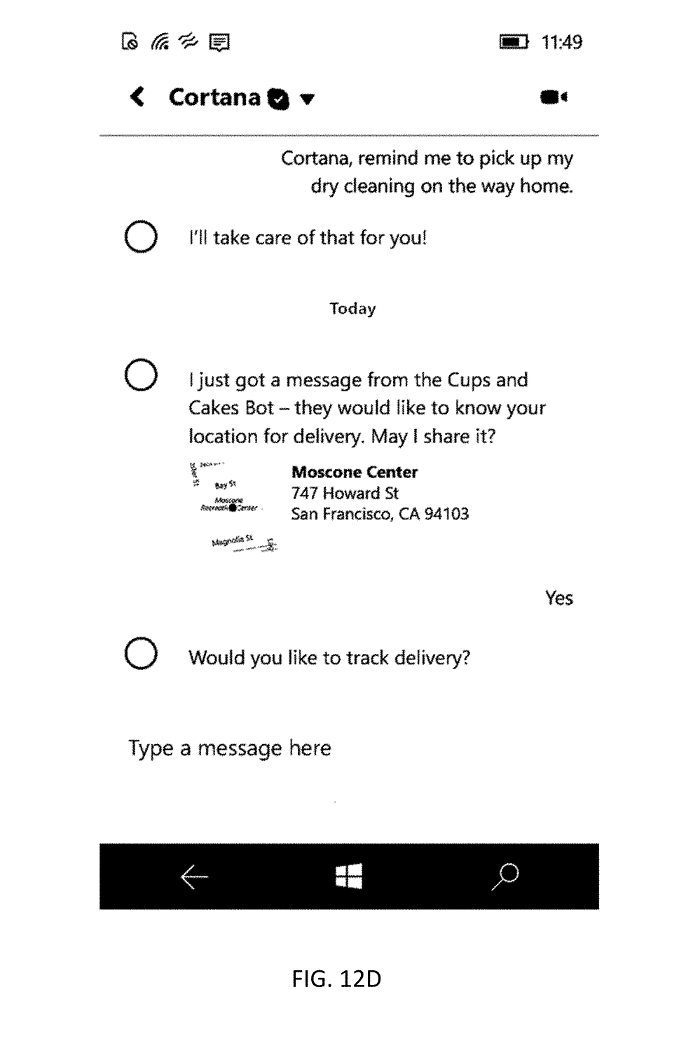

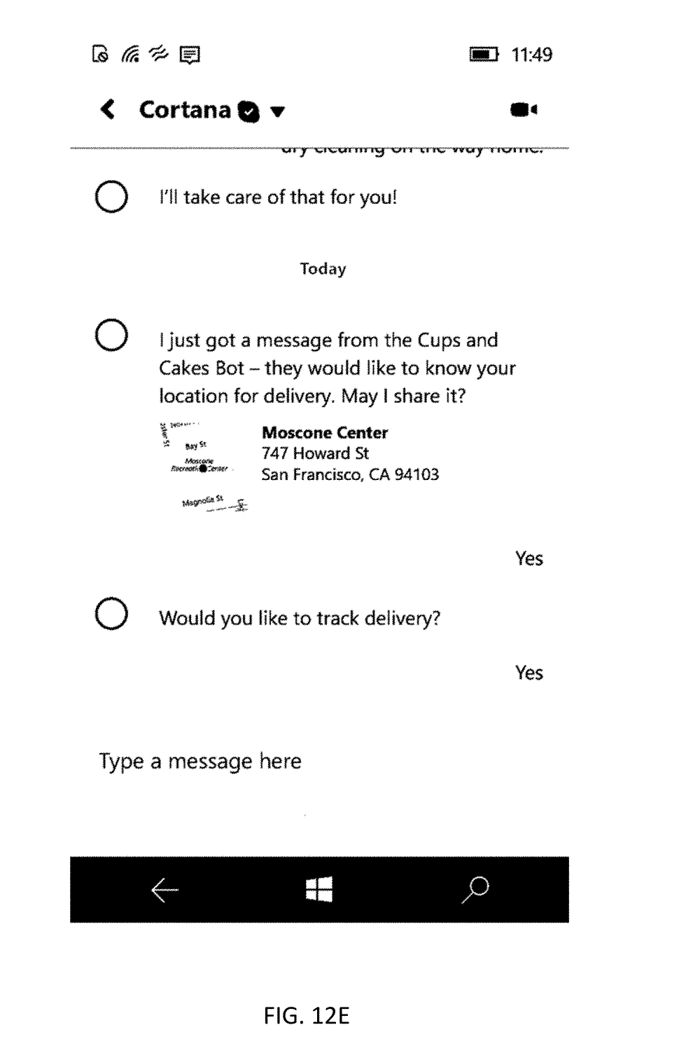

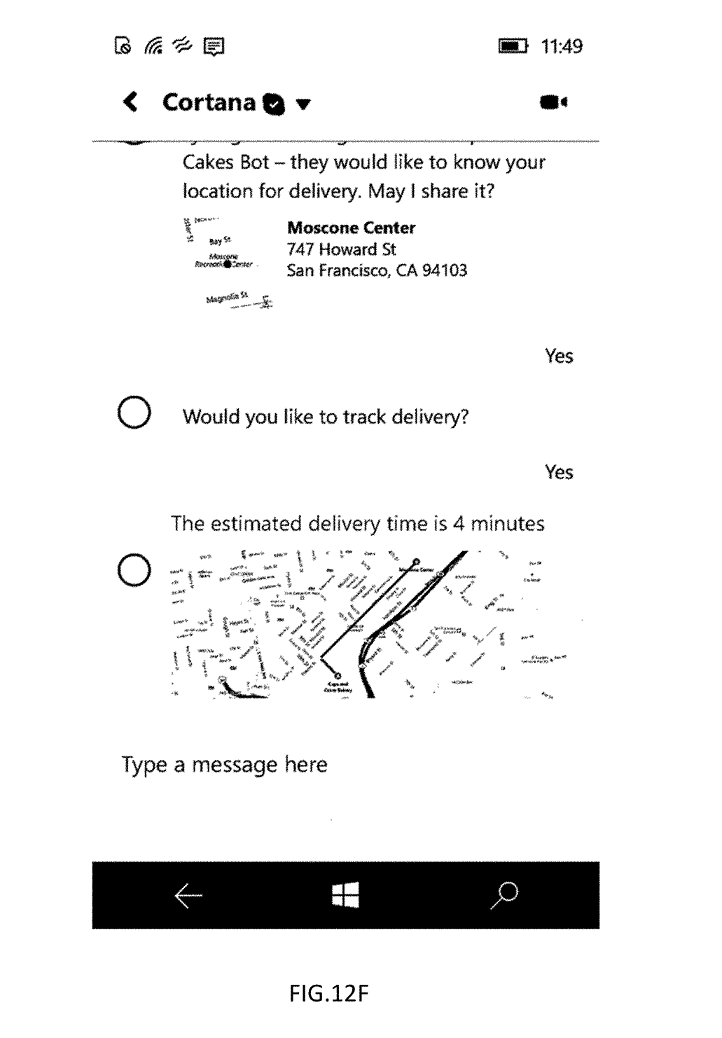

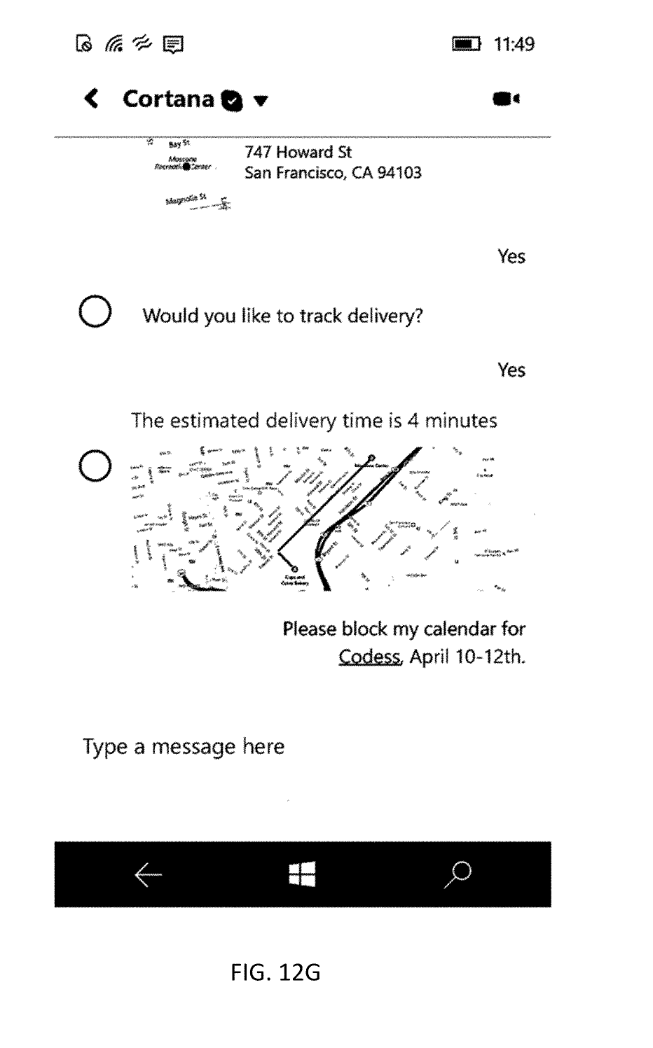

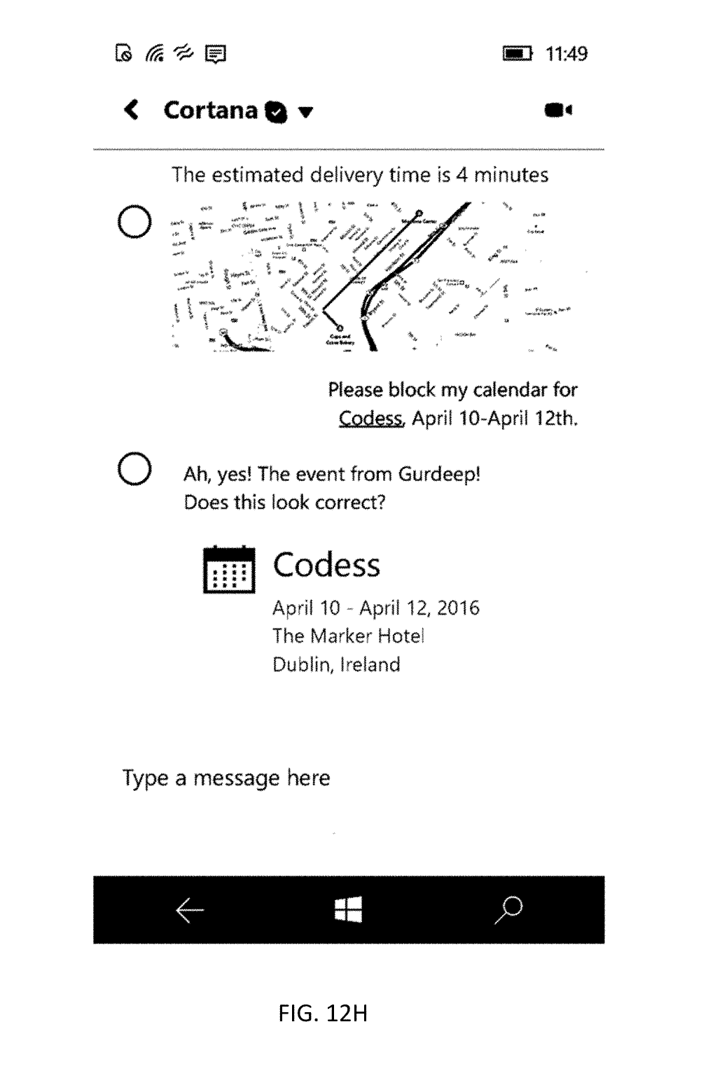

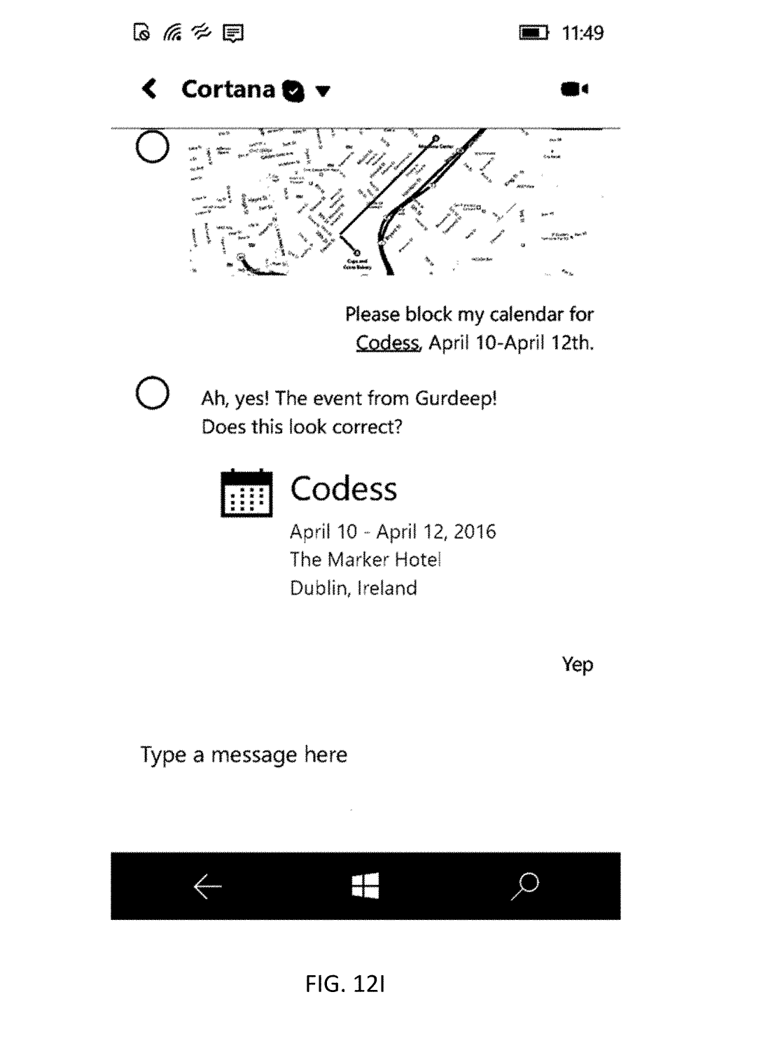

FIGS. 12A-I show a similar user-bot interaction session to that described in relation to FIGS. 8A-D. Specifically, FIGS. 12A-I illustrate the messages as appearing on the user interface display of the user terminal. In FIGS. 12A-I, the user's personal assistant bot (“Cortana”) relays information between the user and “Cups and Cakes bot” in order to facilitate the user ordering a cupcake. Cortana also relays information and permissions relating to delivery tracking. As shown in FIGS. 12A-I, the user's interaction with the bot is substantially conversational in the sense that the user is able to message the bot in the same way, and through the same messaging client, as they would message a human user.

Bot Portal

It is appreciated from the above description that many bots may serve a variety of general and specific functions. The present invention further recognizes that users (developers) may be able to create their own bots. In this case, other users (including non-developers) may wish to share bots with each other. The present invention therefore provides a bot provisioning service or “bot portal” that allows a developer to either upload or identify the location of a bot. The portal also allows the user to specify the capabilities of the bot.

The portal provides a bot provisioning service in the form of a computer system (also called a “back end”) comprising one or more computer devices, the computer system providing the provisioning service of autonomous software agents (bots), the computer device comprises a user interface generating component, a storage interface component, and an access component.

The user interface generating component provides the portal to a human user via a display, i.e. the user interface generating component is a controller operable to control a display in order to display the portal to a human user. That display may be the display on a user's personal device or may be local to the computer system back end itself. In either case, the display might be a display of a developer's device (a bot developer) via which the developer can access the portal in order to upload, access and/or edit his bots. The portal has entry fields for receiving agent data from the human user (e.g. developer)

The storage interface component accesses computer storage that stores autonomous software agents. That is, the bots themselves can be stored anywhere (not necessarily at the computer system itself, though that is possible). The bots may also be stored in a distributed fashion (see the discussion of calling/audio webhooks later). Hence, the storage interface component allows the computer system to access the bots from the computer storage.

The access component holds an association between the agent data and a network address of an agent. E.g. a list of bot names and the network addresses at which they are each stored. Note that each bot may have more than one network address defining a location of the computer storage in a computer network at which the agent is stored because, as mentioned above, the bots may be stored in a distributed manner. When an entity (such as a developer or other user) selects an agent based on the agent data, the access component enables automated access to the agent based on the network address.

The portal takes bot metadata (such as name, endpoint, etc.) and makes it available in a lookup that a user may optionally consume (via Skype) to add the bot as a contact into their address book. That is, the portal provides a registry of all the registered bots. Users can then access the portal and find bots to choose to add as contacts on their messaging client. Note that there may be cases in which a bot may automatically be added to a user's address book, such as:

Cortana bot (this was a business decision, not a technical one)

Concierge bot (new users only, this is a bot that provides helpful hints and tips)

Developers who own or are engineering a given bot.

Regarding the developers (above), a developer of a “WidgetBot”, might automatically get WidgetBot propagated as a contact to his address book because he is a developer and has made his IM ID known to the portal. WidgetBot would not be automatically propagated to someone else's address book, but once the developer has published WidgetBot, other users would be able to add it as a contact using an IM client like any other bot.

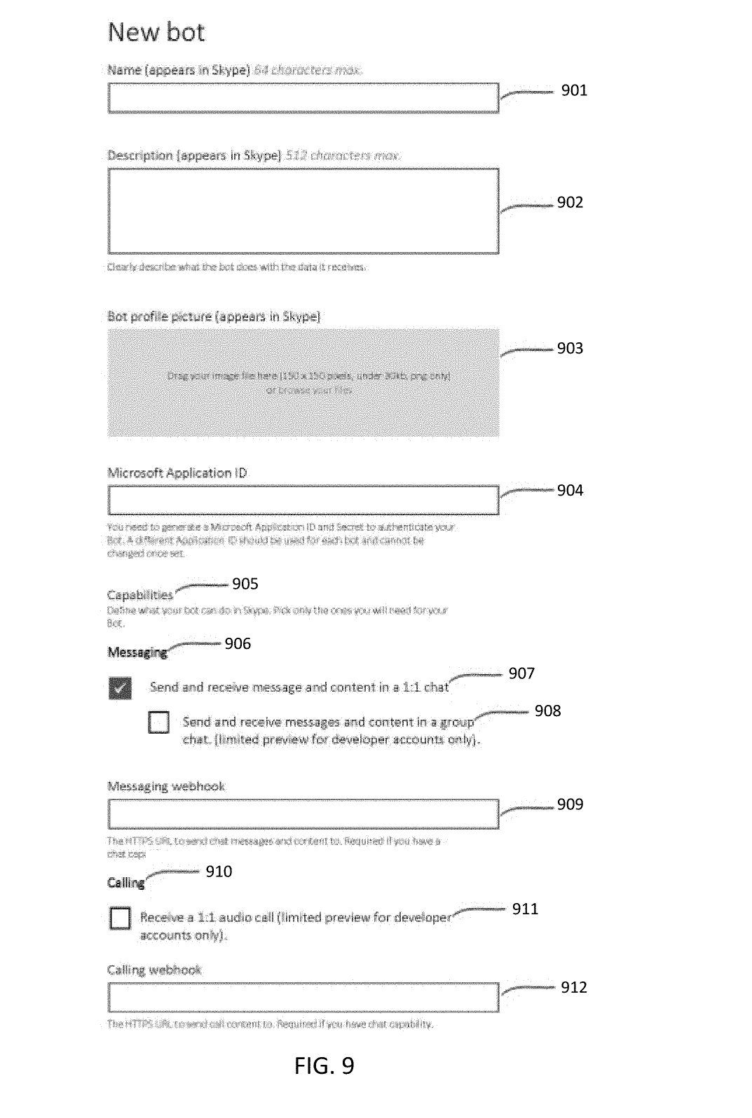

FIG. 9 illustrates an example of a portal screen which is displayed to a user on the display 205 their respective user terminal 106, though it is not excluded that the user may be able to access the portal via any other computing device.

Specifically, FIG. 9 shows an example form by which a user may upload a bot to the portal. The form includes fields for a bot name 901, a description 902, a profile picture 903, an ID 904, and a section relating to the bot's capabilities 905. The capabilities section allows the user to specify the messaging capabilities of the bot, shown are a one-to-one messaging capability 907 (i.e. can the bot function in a one bot to one user messaging scenario), a group messaging capability 908 (i.e. can the bot function in a one bot to multiple user group messaging scenario), and an audio calling capability 910. The audio calling capability 910 is shown as a one-to-one capability, but it is not excluded than a group audio calling capability may be provided.

Fields for entering a messaging webhook 909 and a calling webhook 912 are also shown. The webhooks are the network addresses to which user messages and calls, respectively, will be routed by the IM client. In this sense, they are the equivalents of a normal (human) user's contact addresses. Separate calling and messaging webhooks may be used when the bot is stored in a distributed fashion. In which case audio calls may be routed differently than textual messages.

The information relating to the bot entered by the user may be considered metadata which may include both logical and functional data. Logical data is information relating to the bot category (e.g. hotel, food, flights, etc.) of what service the bot provides to the user. Functional data is data relating to the messaging client specifically (e.g. calling capabilities, network addresses, etc.). Other information may also be included such as bot name, a description, and/or a profile picture.

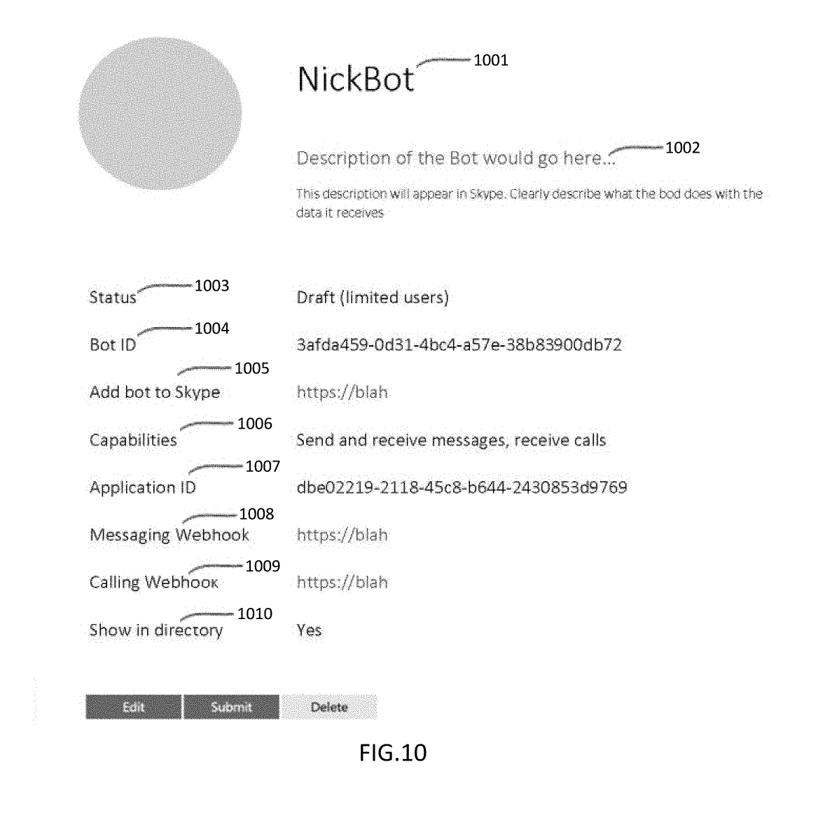

Once a user has entered the bot metadata (e.g. using a form such as the one shown in FIG. 9), the bot may be published to the portal. This allows other users to search for and find the bot. An example of how a bot might appear in the portal is shown in FIG. 10.

In FIG. 10, the bot is shown as a list of bot metadata: name 1001, description 1002, status 1003, Bot ID 1004, add link 1005, capabilities 1006, application ID 1007, messaging webhook 1008, calling webhook 1009, and visibility 1010. Any or all of the metadata may be searchable by users in order to find a bot. Note however that the visibility 1010 may be turned off in order to hide a bot from search results.

The description 1002 should include details about logical capabilities of the bot. I.e. what the bot actually does, preferably in human-readable text. For example, specifying that the bot is a “hotel booking bot” or a “pizza ordering bot”. The logical capabilities of the bot may be categorised to ease searching, e.g. “hotel”, “food”. The logical capabilities may also be more specific such as specifying the particular company or brand which the bot represents.

The status 1003 allows users to see the status of the bot. For example, there may be a review period for new bots in which the admin of the bot provisioning service review bots before allowing them to be accessed from the portal. In this case a bot may be listed on the portal as “in review”, “approved”, “rejected”, etc. (though preferably rejected bots would be removed from the portal entirely). Alternatively, a bot may be (perhaps temporarily) “blocked” in which case a user may see that the bot exists on the portal, but may not be able to add it as a contact.

The bot ID 1004 uniquely identifies the bot on the portal. The ID may be provided by the admin of the bot provisioning service.

The add link 1005 specifies a link which allows a user to add the bot as an IM contact, either directly (e.g. a hyperlink) or indirectly (e.g. by specifying the bot's address which the user needs to add as a contact, in the same way that the user may add a human contact).

The capabilities 1006 of the bot include at least what type of messaging the bot provides, e.g. text messaging, group chat, audio/video calls, etc.

The application ID 1007 uniquely identifies the application.

Messaging webhook 1008 and calling webhook 1009 are the network addresses to which text and voice/video messages sent by the user will be routed, respectively.

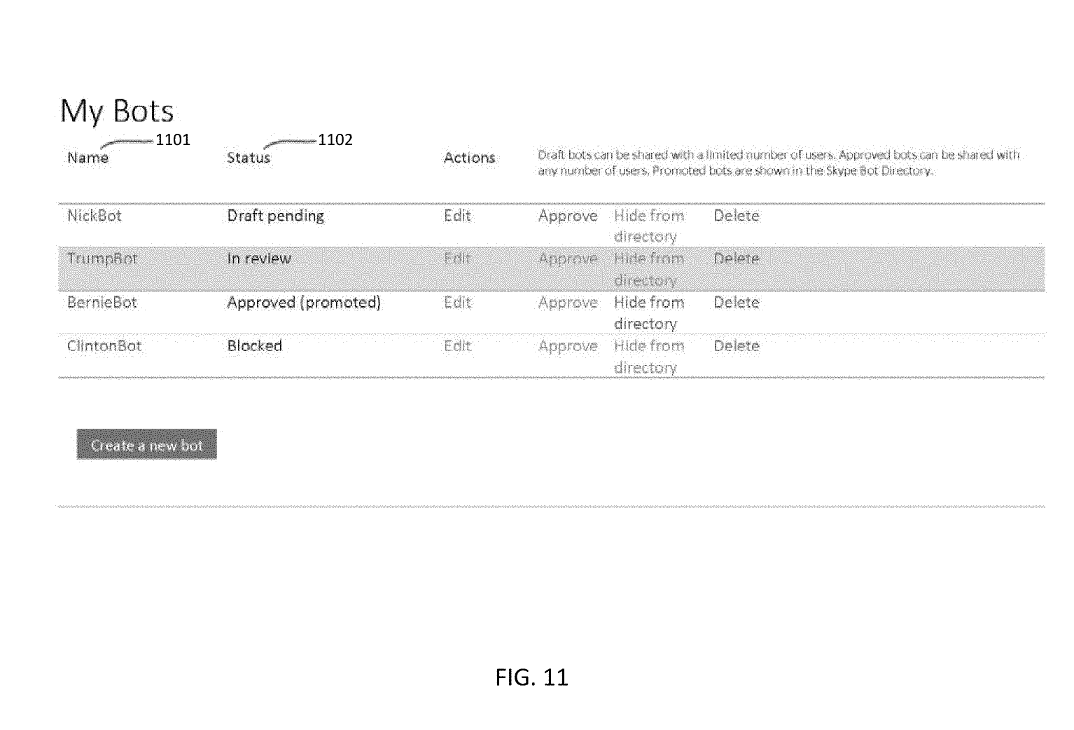

FIG. 11 shows an example of a portal displaying a list of (multiple) bots created by a user. That is, a user who has created multiple bots (i.e. a developer) and submitted them to the portal.

In this regard, the portal may present the user with a list of his bots and a summary of their status (shown as name 1101 and status 1102, though other metadata might also be included). The portal allows the user to edit their bots, view their status (e.g. in review), manage privacy settings, and delete their bots.

It is appreciated, as outlined above, that bots may require permission to access certain information relating to a user (e.g. credit card details). Hence, it is understood that the bot metadata stored on the portal may include information pertaining to said permission, e.g. whether the bot requires access to a user's credit card details, and therefore that the user must provide this permission in order for the bot to function. The permission metadata may also include hardware permissions such as whether the bot requires access to a webcam or speakers or a user's terminal. The permission metadata may also include other permission data such as legal waivers.

Generally, any of the functions described herein can be implemented using software, firmware, hardware (e.g., fixed logic circuitry), or a combination of these implementations. The terms “module,” “functionality,” “component”, and “logic” as used herein generally represent software, firmware, hardware, or a combination thereof. In the case of a software implementation, the module, functionality, or logic represents program code that performs specified tasks when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors.

For example, the user terminals may also include an entity (e.g. software) that causes hardware of the user terminals to perform operations, e.g., processors, functional blocks, and so on. For example, the user terminals may include a computer-readable medium that may be configured to maintain instructions that cause the user terminals, and more particularly the operating system and associated hardware of the user terminals to perform operations. Thus, the instructions function to configure the operating system and associated hardware to perform the operations and in this way result in transformation of the operating system and associated hardware to perform functions. The instructions may be provided by the computer-readable medium to the user terminals through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Computer-readable storage media do not include signals per se. Examples of a computer-readable storage medium include a random-access memory, read-only memory (ROM), an optical disc, flash memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A user terminal comprising:
a processor comprising one or more processing devices configured to run a communication client to establish communication event with nodes in a communication network;
a display on which the communication client causes contact identifiers to be displayed, each contact identifier being selectable to initiate a communication event with a node addressed by the contact identifier; and
a user interface enabling a user to engage in an interaction with the user terminal, the interaction including communicating via an established communication events with at least one other node in the communication network associated with a human user,
whereby messages in the communication event are available to an autonomous software agent (ASA) to convey an intent conveyed in a dialogue between the user terminal and the human user at the at least one other node, and the processor is configured to receive and present to the user a response to the intent received from the ASA and wherein the processor is further configured, on a user sign on with the communication client, to convey an authentication token for access by the ASA.

2. The user terminal according to claim 1, wherein the interaction includes communicating via the established communication event also with at least one other node in the communication network associated with the ASA.

3. The user terminal according to claim 1, wherein said message is conveyed as part of said communication event.

4. The user terminal according to claim 1, wherein the dialogue from which the intent is conveyed to the ASA is a current dialogue in which the user is engaged.

5. The user terminal according to claim 4 wherein the communication event in which the dialogue is conducted is a video or audio call, wherein a video or audio stream of the call is made available to the ASA.

6. The user terminal according to claim 1 wherein the communication event from which the intent is conveyed is a historic event.

7. The user terminal according to claim 1 wherein the processor is configured to access context data of the user and to make the context data available to the ASA.

8. The user terminal according to claim 7 wherein the processor is configured to make the context data available to the ASA subject to permission being granted by the user through engagement with the UI.

9. The user terminal according to claim 8 wherein the processor is configured to receive a request for permission from the ASA and to display it on the UI.

10. The user terminal according to claim 1 wherein the processor is configured to receive a request for authentication of the user by the ASA, and to supply an authentication token responsive to the request.

11. A computer implemented method of autonomously actioning a user intent, comprising
displaying contact identifiers on a display of a user terminal associated with the user, each contact identifier being selectable to initiate a communication event with a node addressed by the contact identifier;
establishing communication events with nodes in a communication network, responsive to user selection of contact identifiers associated with the node; and
communicating via respective established communication events with at least one other node in the communication network associated with a human user, whereby messages in the communication event are available to an ASA to convey an intent conveyed in a dialogue between the user terminal and the human user at the at least one other node and, based on a user sign on with the communication client, conveying an authentication token for access by the ASA; and
receiving and presenting to the user a response to the intent received from the ASA.

12. The method according to claim 11, wherein the dialogue from which the intent is conveyed to the ASA is a current dialogue in which the user is engaged.

13. The method according to claim 12, wherein the communication event in which the dialogue is conducted is a video or audio call, wherein a video or audio stream of the call is made available to the ASA.

14. The method according to claim 11 wherein the communication event is an IM session, wherein text of messages in the session are made available to the ASA.

15. A method according to claim 11 wherein the communication event from which the intent is conveyed is a historic event.

16. The method according to claim 11 comprising accessing context data of the user and making the context data available to the ASA.

17. The method according to claim 16 comprising receiving a request for permission from the ASA and displaying it to the user, whereby a user can engage with the request to grant permission for the context data to be accessed.

18. The method according to claim 11 comprising receiving a request for authentication of the user by the ASA, and supplying an authentication token responsive to the request.

19. A computer program product comprising computer readable code stored on computer readable media which when run by a computer carries out operations comprising:
displaying contact identifiers on a display of a user terminal associated with the user, each contact identifier being selectable to initiate a communication event with a node addressed by the contact identifier;
establishing a communication event with nodes in a communication network, responsive to user selection of contact identifiers associated with the node;
communicating via respective established communication events with at least one other node in the communication network associated with a human user, whereby messages in the communication event are available to an autonomous software agent (ASA) to convey an intent conveyed in a dialogue between the user terminal and the human user at the at least one other node and whereby the processor is configured, on a user sign on with the communication client, to convey an authentication token for access by the ASA; and
receiving and presenting to the user a response to the intent received from the ASA.

20. The computer program product as recited in claim 19, wherein the dialogue from which the intent is conveyed to the ASA is a current dialogue in which the user is engaged.
